(19) United States
(12) Patent Application Publication
(10) Pub. No.: US 2025/0067936 A1
(43) Pub. Date: Feb. 27, 2025

(54) Photonic Waveguide Networks

(71) Applicant: PsiQuantum Corp., Palo Alto, CA (US)

(72) Inventors: Hugo V. Cable, San Mateo, CA (US); Damien Bonneau, Bristol (GB); Hsuan-Tung Peng, Palo Alto, CA (US); Bryan S. Park, Campbell, CA (US); Andrzej Perez Veitia, Campbell, CA (US); Sara Bartolucci, San Francisco, CA (US); Eric Dudley, Sacramento, CA (US); Mihai Vidrighin, Palo Alto, CA (US)

(21) Appl. No.: 18/943,669

(22) Filed: Nov. 11, 2024

Related U.S. Application Data
(63) Continuation of application No. PCT/US2023/022144, filed on May 12, 2023.
(60) Provisional application No. 63/430,988, filed on Dec. 7, 2022.
(60) Provisional application No. 63/341,374, filed on May 12, 2022.

(51) Int. Cl. G02B 6/28

(52) U.S. Cl. CPC G02B 6/2804

(57) ABSTRACT

An example photonic integrated circuit (PIC) includes a plurality of input ports to input light, such as a quantum state of light that comprises one or more photons, into the PIC. In addition, the PIC may include a waveguide network that includes a crossing network to combine light, and optical couplers that are coupled to the crossing network. The PIC can further include output ports to output the light.

### RELATED APPLICATIONS

This application is a continuation of PCT Patent Application Serial No. PCT/US2023/022144, filed May 12, 2023, which claims the benefit of and priority to U.S. Provisional Patent Application No. 63/430,988, entitled “Photonic Switch-Based Information Processing” filed Dec. 7, 2022, and to 63/341,374, entitled “Generalized Mach-Zehnder Interferometer Systems and Components” filed May 12, 2022, each of which is hereby incorporated by reference in its entirety.

### TECHNICAL FIELD

The present disclosure generally relates to optical devices, and more particularly to couplers.

### BACKGROUND

Photonic switches operate to selectably direct light from one of a set of input paths to one of a set of output paths. In some switches, paths can be selected by operating active optical components to provide the desired optical coupling and/or to suppress undesired optical couplings. Photonic switches have a variety of applications, including different types of linear optical circuits. In quantum photonic circuits and systems, photons may be generated at different times and propagated through different waveguides. For various operations, it may be desirable to rearrange photons spatially onto different waveguides and/or to synchronize photons propagating on different waveguides so that they arrive at a particular location within the circuit and/or with a particular timing.

For the case of linear optical quantum computing, the hardware footprint for a full-scale photonic quantum computer can significantly depend on the size of the photonic network used to generate the entangles states, known as resource states, that are used for quantum information processing. There are different ways to generate a resource state, initial steps can include muxing operations on single photon states generated by single photon sources and by circuits for creating Bell or GHZ states. Muxing uses a switch network to relocate photonic quantum states to target spatio-temporal bins from non-deterministic inputs. Because switch networks are used for muxing and routing resource states, their practical constraints can have a dramatic impact on the overall hardware footprint of the quantum computer.

### BRIEF DESCRIPTION OF THE DRAWINGS

The following description includes discussion of figures having illustrations given by way of example of implementations of embodiments of the disclosure. The drawings should be understood by way of example, and not by way of limitation. As used herein, references to one or more “embodiments” are to be understood as describing a particular feature, structure, or characteristic included in at least one implementation of the inventive subject matter. Thus, phrases such as “in one embodiment” or “in an alternate embodiment” appearing herein describe various embodiments and implementations of the inventive subject matter, and do not necessarily all refer to the same embodiment. However, they are also not necessarily mutually exclusive. To easily identify the discussion of any particular element or act, the most significant digit or digits in a reference number refer to the figure (“FIG.”) number in which that element or act is first introduced.

FIG. 1 shows a photonic switch-based information processing system 101 in accordance with some embodiments.

FIGS. 2A-2C show example quantum-light switch architectures in accordance with some embodiments.

FIG. 2D shows an example fabrication stack of a Photonic Integrated Circuit (PIC) wafer in accordance with some embodiments.

FIGS. 3A-3C show example Generalized Mach-Zehnder Interferometers (GMZI) architectures in accordance with some embodiments.

FIGS. 4 and 5 show example GMZI configurations in accordance with some embodiments.

FIGS. 6A and 6B show example GMZI components and configurations in accordance with some embodiments.

FIG. 7 shows an example of bends in a GMZI in accordance with some embodiments.

FIG. 8 shows a GMZI with first and second phase shifters on each arm in accordance with some embodiments.

FIGS. 9A-9C show example coupler network configurations and components in accordance with some embodiments.

FIGS. 10-14C show example architectures for coupler networks and GMZIs in accordance with some embodiments.

FIG. 15 shows example architecture of one or more GMZIs implemented in a Bell State Generator (BSG) device in accordance with some embodiments.

FIG. 16 shows an example Bell State Generator configuration in accordance with some embodiments.

FIG. 17 show an example architecture for implementing multiple GMZIs for routing quantum light to Bell State generators in accordance with some embodiments.

FIG. 18 shows an example architecture of one or more GMZIs implemented in a cluster-state device (e.g., Greenberger-Horne-Zeilinger (GHZ) device) in accordance with some embodiments.

FIG. 19 show an example integration between different quantum-logic devices using first and second phase shifters in accordance with some embodiments.

FIG. 20 shows a flow diagram of a method for multiplexing light in an optical device comprising one or more GMZIs in accordance with some embodiments.

FIG. 21 shows a flow diagram of a method for splitting light in a coupler network (e.g., Hadamard network) in accordance with some embodiments.

FIGS. 22A-22E show scaling of a quantum-light network in accordance with some embodiments.

FIG. 23 shows a self-similar scalable coupler network in accordance with some embodiments.

Descriptions of certain details and implementations follow, including a description of the figures, which may depict some or all of the embodiments described below, as well as discussing other potential embodiments or implementations of the inventive concepts presented herein. An overview of embodiments of the disclosure is provided below, followed by a more detailed description with reference to the drawings.

### DETAILED DESCRIPTION

In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, structures, and techniques are not necessarily shown in detail.

A generalized Mach-Zehnder interferometer (GMZI) is a building block for various quantum computing systems and/or optical communication systems. A GMZI may be implemented using splitter networks and phase shifters to perform routing of light, such as quantum light. The splitter networks may comprise sets of couplers, bends, and crossing couplers to manipulate the quantum light. In some embodiments, a first coupler network separates the quantum light, and a second coupler network combines the quantum light onto one or more output ports. In some embodiments, between the coupler networks are phase-shifter elements (e.g., a first phase shifter for switching, a second phase shifter for trim and calibration) to change a phase of the quantum light on a given arm of the GMZI such that the quantum light is configured according to a transfer matrix and output from the GMZI in various configurations, such as a N-to-1 configuration or a N-to-M configuration.

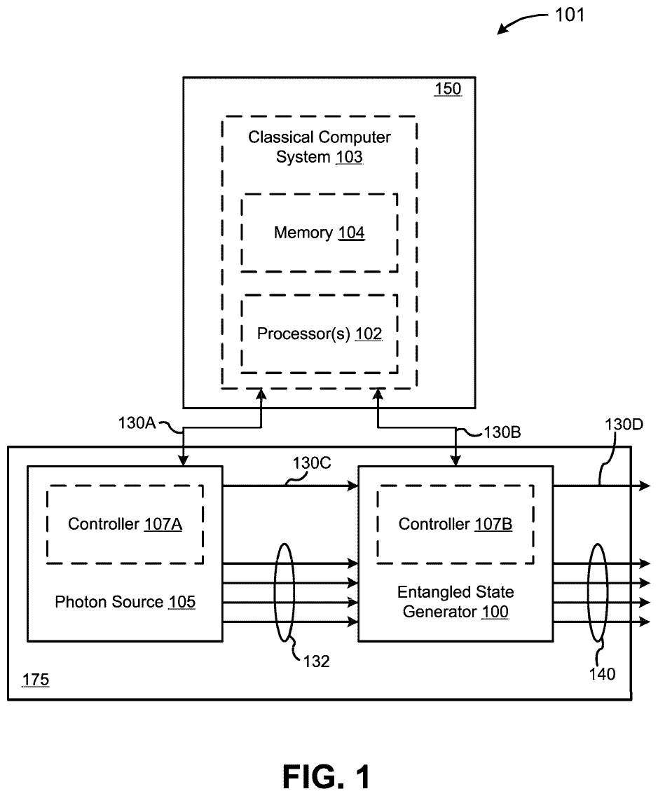

FIG. 1 shows a photonic switch-based information processing system 101 according to some embodiments. In some embodiments, the photonic switch-based information processing system 101 comprises an electronic information processing architecture 150 and a photonic processing architecture 175. The electronic information processing architecture 150 may process information electronically (e.g., binary data processing in a circuit, an ASIC, or with one or more central processing units and memory that stores instructions). The photonic processing architecture 175 may process information optically (e.g., classical light information processing such as Pulse Amplitude Modulation (PAM), Phase Shift Keying (PSK), or Quadrature Amplitude Modulation (QAM) signaling of light beams, or non-classical light information processing that uses extremely low levels of light, such as single-photon or entangled-photon processing and detection).

The photonic switch-based information processing system 101 may be used to generate qubits (e.g., photons) in an entangled state (e.g., a GHZ state or a Bell pair state) in accordance with some embodiments. In an example photonic architecture, the photonic switch-based information processing system 101 may include a photon source module 105 that is optically connected to the entangled state generator 100. Both the photon source module 105 and the entangled state generator 100 may be coupled to a classical computing system 103 such that the classical computing system 103 may communicate and/or control the photon source module 105 and/or the entangled state generator 100. The communication and/or control may be via the classical information channels 130A or 130B. The photon source module 105 may include a collection of single-photon sources. The single-photon sources may provide output photons to the entangled state generator 100 by way of one or more interconnecting waveguides 132. The entangled state generator 100 may receive the output photons and convert them to one or more entangled photonic states. Then, entangled state generator 100 may output these entangled photonic states into one or more output waveguides 140. In some embodiments, the output waveguides 140 are coupled to one or more downstream circuit that use the entangled states to perform a quantum computation. For example, the entangled states generated by the entangled state generator 100 may be used as resources for a downstream quantum optical circuit.

In some embodiments, the photonic switch-based information processing system 101 includes one or more classical information channels 130 (e.g., classical information channels 130A-D) for interconnecting and providing classical information between components. It should be noted that classical information channels 130A-130D need not all be the same. For example, one or more of the classical information channels 130A-130C may comprise a bi-directional communication bus carrying one or more reference signals, e.g., one or more clock signals, one or more control signals, or one or more signals that carries classical information, e.g., heralding signals or photon detector readout signals.

In some embodiments, the photonic switch-based information processing system 101 includes the classical computer system 103 that communicates with and/or controls the photon source module 105 and/or the entangled state generator 100. For example, in some embodiments, a classical computer system 103 is used to configure one or more circuits, e.g., providing a system clock the photon source module 105, the entangled state generator 100, or downstream quantum photonic circuits used for performing quantum computation. In some embodiments, the quantum photonic circuits may include optical circuits or electrical circuits. In some embodiments, a classical computer system 103 includes memory 104, one or more processor(s) 102, a power supply, an input/output (I/O) subsystem, and one or more communication busses for interconnecting these components. The processor(s) 102 may execute modules, programs, and/or instructions stored in the memory 104 and thereby perform processing operations.

In some embodiments, the memory 104 stores one or more programs (e.g., sets of instructions) and/or data structures. In some embodiments, the entangled state generator 100 attempts to produce an entangled state over successive stages, any one of which may be successful in producing an entangled state. In some embodiments, memory 104 stores one or more programs for determining whether a respective stage was successful and configuring the entangled state generator 100 accordingly. For example, upon determining that a respective stage was successful, the entangled state generator 100 is configured to switch the photons to an output. In another example, upon determining that a respective stage was not successful, the entangled state generator 100 is configured to pass the photons to the next stage of the entangled state generator 100. In some embodiments, the memory 104 stores detection patterns (described below). Based on the detection patterns, the classical computing system 103 may determine whether a stage was successful. In addition, the memory 104 may store settings that are provided to the various configurable components (e.g., switches) described herein that are configured by, e.g., setting one or more phase shifts for the component.

In some embodiments, some or all of the above-described functions are implemented with hardware circuits on the photon source module 105 and/or the entangled state generator 100. In some embodiments, a photon source module 105 includes one or more controllers 107A (e.g., logic controllers) (e.g., field programmable gate arrays (FPGAs), application specific integrated circuits (ASICS), or a “system on a chip” that includes classical processors and memory). In some embodiments, the controller 107A determines whether the photon source module 105 was successful (e.g., for a given attempt on a given clock cycle, described below) and outputs a reference signal indicating whether the photon source module 105 was successful. In some embodiments, the controller 107A outputs a logical high value to the classical information channel 130A and/or the classical information channel 130C when the photon source module 105 is successful and outputs a logical low value to the classical information channel 130A and/or the classical information channel 130C when the photon source module 105 is not successful. In some embodiments, the output of the controller 107A is used to configure hardware in the controller 107B.

In some embodiments, the entangled state generator 100 includes one or more controllers 107B (e.g., logical controllers) (e.g., which may comprise field programmable gate arrays (FPGAs), application specific integrated circuits (ASICS), or the like) that determine whether a respective stage of entangled state generator 100 has succeeded, perform the switching logic described above, and output a reference signal to the classical information channels 130B and/or 130D to inform other components as to whether the entangled state generator 100 has succeeded.

In some embodiments, a system clock signal is provided to the photon source module 105 and the entangled state generator 100 via an external source or by the classical computing system 103 via the classical information channels 130A and/or 130B. In some embodiments, the system clock signal provided to the photon source module 105 triggers the photon source module 105 to attempt to output one photon per waveguide. In some embodiments, the system clock signal provided to the entangled state generator 100 triggers, or gates, sets of detectors in the entangled state generator 100 to attempt to detect photons. For example, triggering a set of detectors in the entangled state generator 100 to attempt to detect photons includes gating the set of detectors.

In some embodiments, the photon source module 105 and/or the entangled state generator 100 has an internal clock. For example, the photon source module 105 may have an internal clock generated and/or used by the controller 107A, and the entangled state generator 100 may have an internal clock generated and/or used by the controller 107B. In some embodiments, the internal clock of the photon source module 105 and/or the entangled state generator 100 is synchronized to an external clock (e.g., the system clock provided by the classical computer system 103) (e.g., through a phase-locked loop). In some embodiments, any of the internal clocks may be used as the system clock, e.g., an internal clock of the photon source may be distributed to other components in the system and used as the master/system clock.

In some embodiments, the photon source module 105 includes a plurality of probabilistic photon sources that are spatially and/or temporally multiplexed (e.g., multiplexed single photon sources). In one example of such a source, the source is driven by a pump, e.g., a light pulse, which is coupled into an optical resonator that, through some nonlinear process (e.g., spontaneous four wave mixing or second harmonic generation) generates zero, one, or more photons. As used herein, the term “attempt” is used to refer to the act of driving a photon source with some sort of driving signal, e.g., a pump pulse, that may produce output photons non-deterministically (e.g., in response to the driving signal, the probability that the photon source will generate one or more photons may be less than 1). In some embodiments, a respective photon source may be most likely to, on a respective attempt, produce zero photons (e.g., there may be a 90% probability of producing zero photons per attempt to produce a single photon). The second most likely result for an attempt may be production of a single-photon (e.g., there may be a 9% probability of producing a single-photon per attempt to produce a single-photon). The third most likely result for an attempt may be production of two photons (e.g., there may be an approximately 1% probability of producing two photons per attempt to produce a single photon). In some circumstances, there may be less than a 1% probability of producing more than two photons.

In some embodiments, the apparent efficiency of the photon sources is increased by using a plurality of single-photon sources and multiplexing the outputs of the plurality of photon sources.

The precise type of photon source used is not critical and any suitable type of source may be used, employing any suitable photon generating process, such as spontaneous four wave mixing (SPFW) or spontaneous parametric down-conversion (SPDC). Other classes of sources that do not necessarily require a nonlinear material may also be employed, such as those that employ atomic and/or artificial atomic systems, e.g., quantum dot sources or color centers in crystals. In some embodiments, sources are coupled to photonic cavities, e.g., for artificial atomic systems such as quantum dots coupled to cavities. Other types of photon sources also exist for SPWM and SPDC, such as optomechanical systems. In some embodiments, the photon sources emit multiple photons already in an entangled state in which case the entangled state generator 100 is not necessary, or alternatively the entangled state generator 100 takes the entangled states as input and generate even larger entangled states.

For the sake of illustration, an example which employs spatial multiplexing of several non-deterministic photon sources is described as an example of a multiplexed photon source. However, many different spatial multiplexing architectures are possible without departing from the scope of the present disclosure. Temporal multiplexing may also be implemented instead of or in combination with spatial multiplexing. Multiplexing schemes that employ log-tree, generalized Mach-Zehnder interferometers, multimode interferometers, chained sources, chained sources with dump-the-pump schemes, asymmetric multi-crystal single photon sources, or any other suitable type of multiplexed architecture may be used. In some embodiments, the photon source may employ a multiplexing scheme with quantum feedback control.

The foregoing description provides an example of how photonic circuits may be used to implement physical qubits and operations on physical qubits using mode coupling between waveguides. In these examples, a pair of modes may be used to represent each physical qubit. Examples described below may be implemented using similar photonic circuit elements.

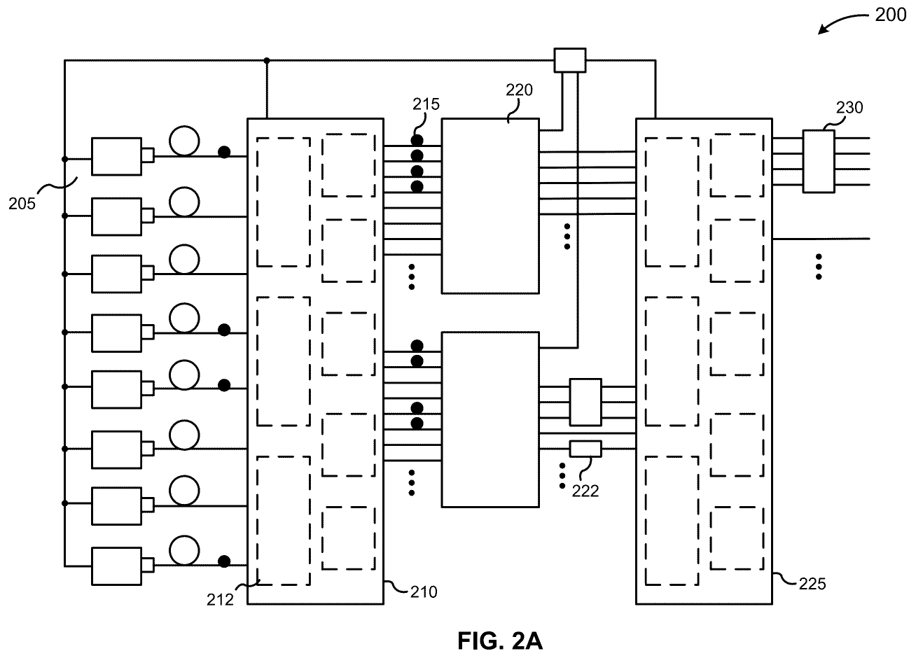

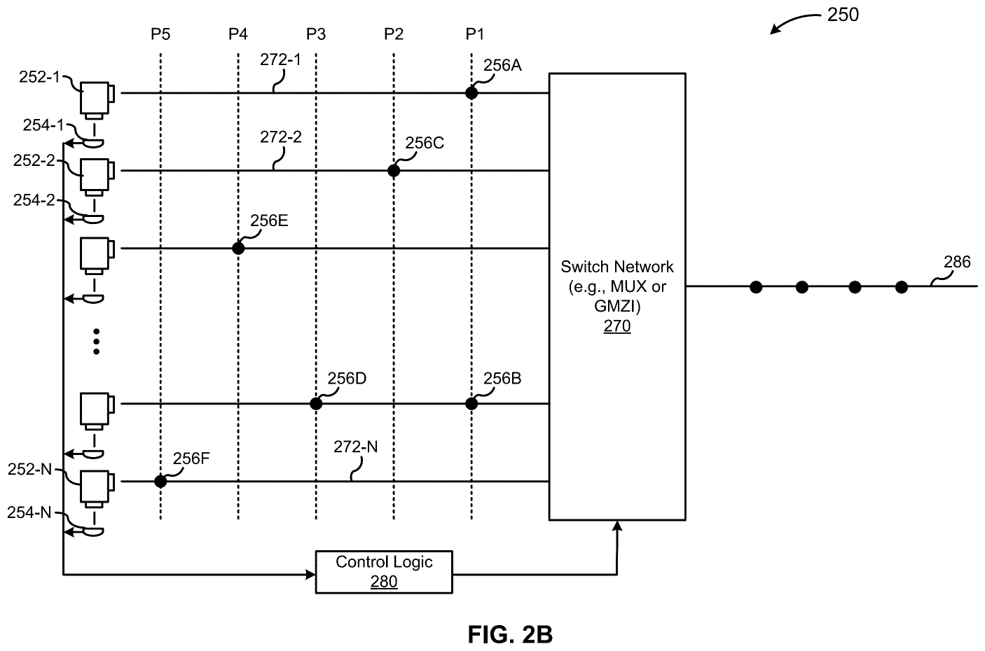

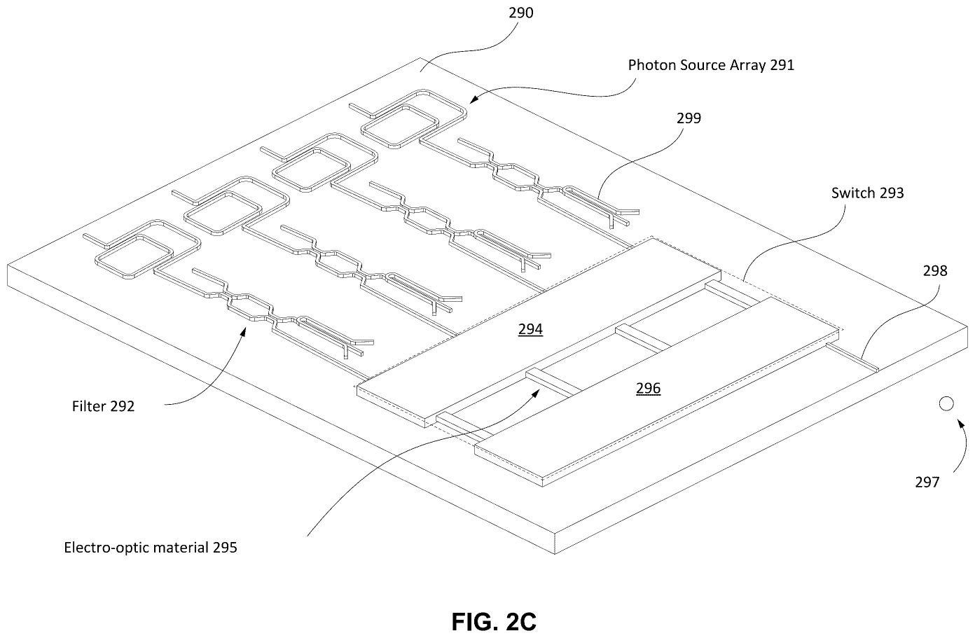

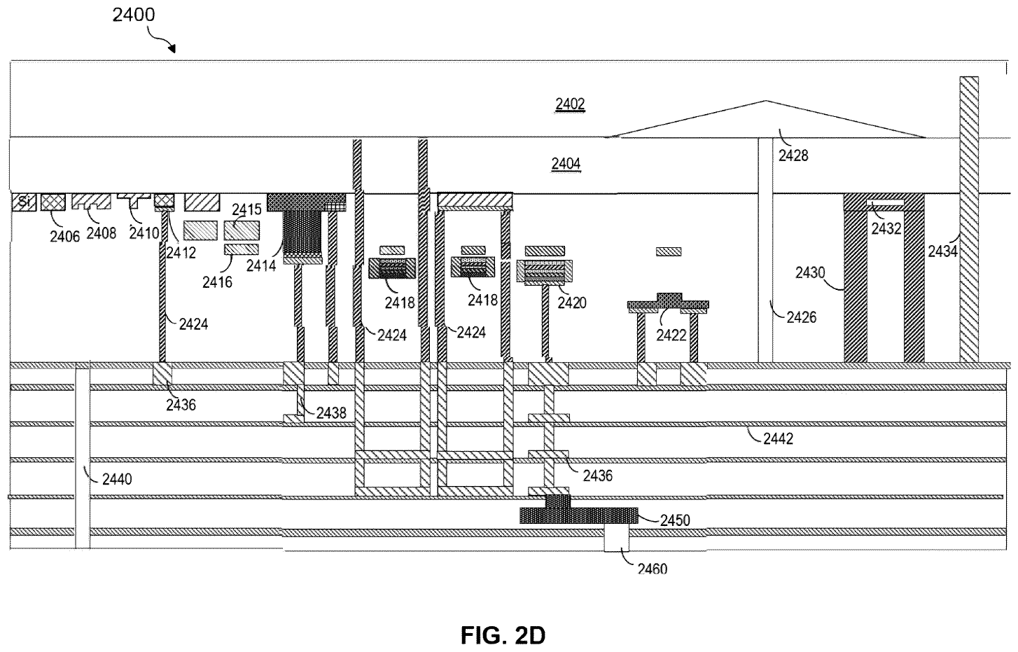

FIG. 2A shows a photonic processing architecture 200 of the photonic switch-based information processing system 101, according to some embodiments. In the example of FIG. 2A, the photonic processing architecture 200 is configured as a spatial multiplexing architecture, although it is appreciated that in other embodiments the photonic architecture is configured for time-based multiplexing that implement time-binned entanglement using switches (e.g., GMZIs). In the example of FIG. 2A, a plurality of optical sources 205 comprise a set of probabilistic optical sources that generate single photons probabilistically (e.g., spontaneous parametric down conversion, four wave mixing, quantum dot generated single photons). In some embodiments, the plurality of optical sources 205 generate pairs of photons and one or more photons in the pairs are detected (e.g., herald photons) to indicate that a successful entangle-able photon has been transmitted towards the first switch network 210. In some embodiments, the detected heralded photons generate source success or fail data bits that are electronically inputted into the first switch network 210 to enable the first switch network 210 to route groups of the entangle-able photons 215 to a photonic entanglement circuit 220 for entanglement. The photonic entanglement circuit 220 receives the entangle-able photons and generates entanglement groups 222 (e.g., photonic resource states comprising three or more entangled photons). In some embodiments, like the plurality of optical sources 205, the photonic entanglement circuit 220 functions probabilistically and successful generation of the entangled groups 222 occurs infrequently. In some embodiments, the photonic entanglement circuit 220 implements one or more optical detections of photons in the photonic entanglement circuit 220 to generate circuit success or fail data that indicates whether a successful entanglement of a group has occurred and further indicates the location of the entangled portions of a given entangled group 222. The circuit success or fail data is electronically communicated to a second switch network 225 for further routing. In some embodiments, the second switch network 225 performs further entanglement operations by merging the entangled photons without detection or otherwise decoherence, such that the switch network outputs one or more entangled qubits 230 for further non-classical optical processing (e.g., quantum communication, quantum experimentation of quantum states, or quantum computing). In some embodiments, the first switch network 210, the photonic entanglement circuit 220, and the second switch network 225 implement optical switches, such as an optical switch 212, to perform both routing and production of photonic entanglements. In some embodiments, the optical switch 212 comprises a generalized Mach-Zehnder interferometer, as discussed in further detail below.

In some embodiments, a Mach Zehnder interferometer comprises a beam splitter that divides an input light into two equal parts which travel on different paths and then combine back together again on a second beam splitter. The path length may be adjusted between the two arms such that the phase difference of classical light (e.g., thermal light, bright light) input into the Mach Zehnder interferometer may cause all of the light to be outputted from a single output port. In some embodiments, the path length that links the different arms is not adjusted but rather physical characteristics of one or more of the arms are modified to implement phase shifts of the light traversing the given arm, thereby enabling the input light to be outputted from a single output port or both output ports. When classical or “bright light” is an input into a given Mach-Zehnder interferometer (MZI), the MZI may function as a splitter or a guide that guides the classical light towards one or more of the output ports. Interestingly, when non-classical light (e.g., single photons, light in a quantum state, fock state) is the input into an MZI, the photon is split and propagates as a superposition of being in each arm at the same time as it propagates through the device. As an example, if the MZI is in a 50/50 splitter configuration (e.g., via path length or active phase adjustments), the superposition of the single photon of quantum light is recombined at the second splitter and there is a 50/50 chance of emerging from either output port. Thus, the MZI may function as a classical and non-classical (e.g., quantum) photonic device.

FIG. 2B shows an example source architecture 250, in accordance with some embodiments. The source architecture 250 is an example time-bin switch architecture for increasing a probability of photon generation using non-deterministic sources (e.g., the plurality of optical sources 205 in FIG. 2A) and a switch network 270 (e.g., the first switch network 210 in FIG. 2A or one or more GMZIs). One technique to improve the likelihood of simultaneously obtaining photons from each of a set of non-deterministic photon sources involves spatial multiplexing of multiple photon sources. The source architecture 250 is configured as a N×1 (or N-to-1) multiplexing circuit for a set of N photon sources 252-1, 252-2 through 252-N (e.g., the plurality of optical sources 205) for some number N, where N≥2. In some embodiments, each photon source 252 is a different physical device that may produce a photon pair in response to a pump pulse (e.g., laser pump pulse). For example, each photon source 252 may be a heralded single photon source as described above. The photon sources 252 may be pumped repeatedly, and each instance of the photon sources 252 (e.g., pump sources) may define a time bin (or temporal mode). For each time bin, each photon source 252 may produce a photon pair. Each photon source 252 has an associated detector 254 (e.g., 254-1, 254-2 through 254-N) and an associated signaling waveguide 272 (e.g., 272-1, 272-2 through 272-N). In some embodiments, in any time bin where a particular photon source 252 does produce a photon pair, one photon propagates through the associated signaling waveguide 272 while the other photon is detected by the associated detector 254.

In each time bin, each photon source 252 may generate a photon. The dots 256A-256F show an example of the photons 256 that may be generated during different time bins P1-P5. FIG. 2B may be regarded as a snapshot view, with the photons 256 produced during different time bins appearing at different locations along the signaling waveguides 272 of different waveguide arms.

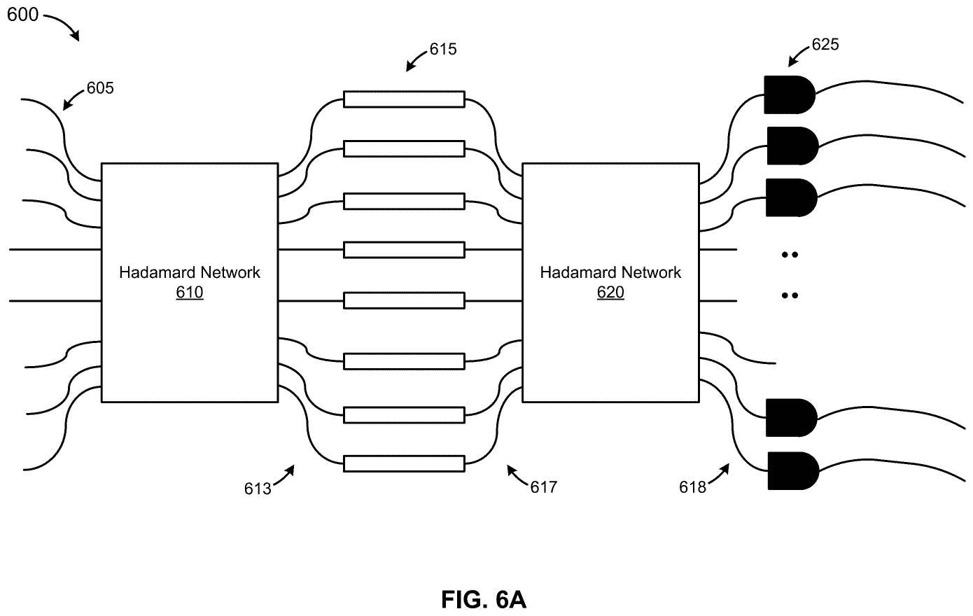

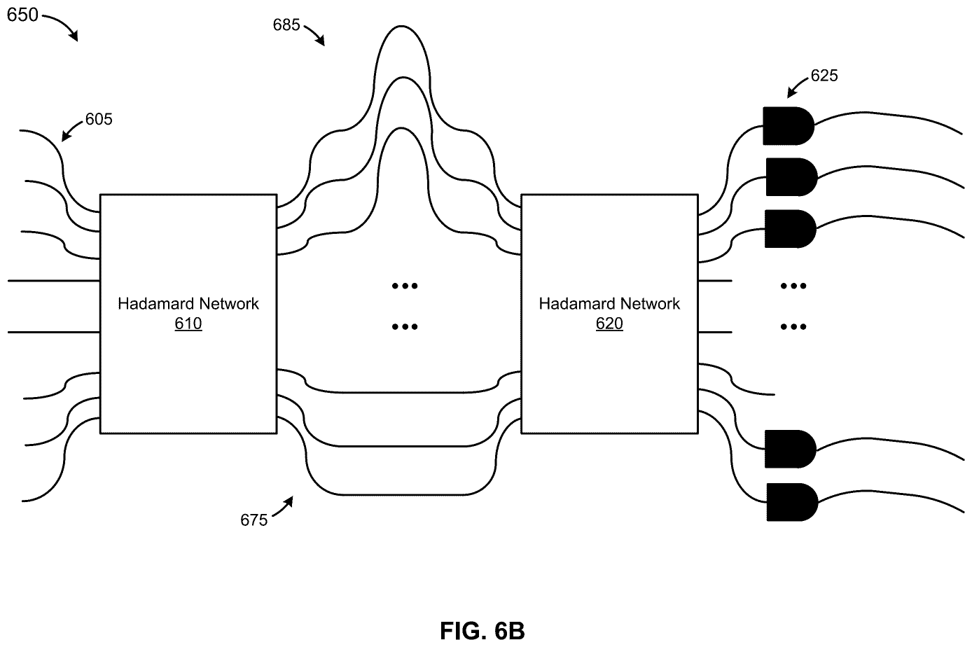

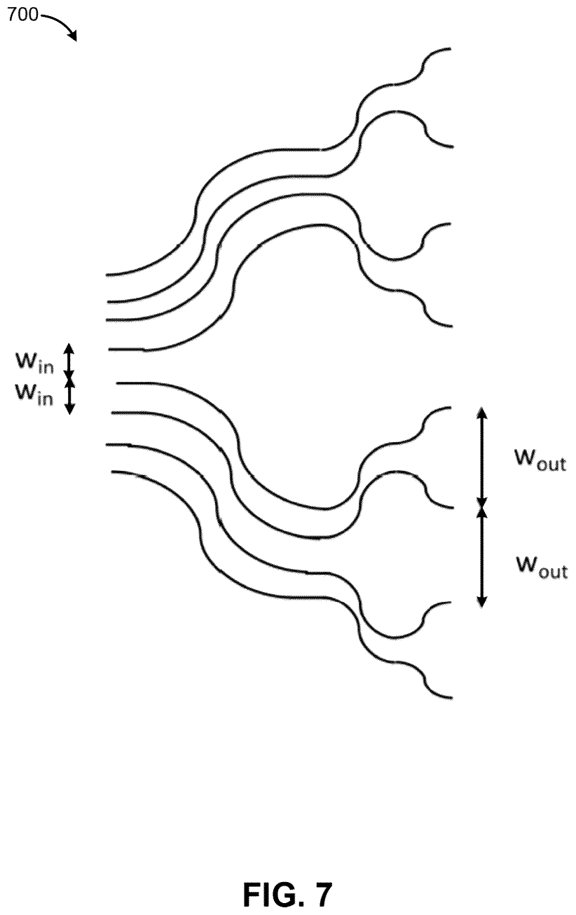

In some embodiments, the switch network 270 is implemented as a N×1 multiplexer (or “mux”) that operates as an active optical switching circuit that selectably couples one of N input waveguides 272 to an output waveguide 286. In some embodiments, selectable optical coupling is provided using active optical switches or other active optical components that may be controlled to either allow or block propagation of photons. For example, a N×1 mux in the switch network 270 can be implemented as an N×1 generalized Mach-Zehnder interferometer (GMZI). In some embodiments, an NxM (or N-to-M) GMZI is an optical circuit that receives photons on a set of N input waveguides and controls a set of active phase shifters to selectably couple M of the received photons to a set of M output waveguides. In some embodiments, one or more of the phase shifters are passive fixed phase shifters for preconfigured phase shifts, as discussed in further detail below with reference to FIG. 6B. In the example of FIG. 2B, the switch network is configured as a M=1 multiplexer that has one output. In some embodiments, the N×1 mux of the switch network 270 is controlled by control logic 280 (e.g., controllers), which can be implemented using a conventional electronic logic circuit. In some embodiments, a control logic 280 receives signals from each of the detectors 254 that indicate, for each time bin, whether a photon was or was not detected by each detector 254. Accordingly, the control logic 280 can determine which of the photon sources 252 produced photons during a given time bin (and therefore which input waveguides 272 are carrying photons for that time bin). For each time bin, the control logic 280 may control the switch network 270 to couple one input waveguide that has a photon to the output waveguide 286. For example, a GMZI includes a set of active phase shifters that can be controlled to apply variable phase shifts along different optical paths, creating either constructive or destructive interference, and the control logic 280 can generate control signals to set the state of each active phase shifter in a GMZI implementing N×1 mux to provide the desired coupling.

In some embodiments, the time bin is as long or short as desired, based on characteristics of the optical circuit or variability in the timing of generating photons in the photon sources 252. In some instances, an interval between time bins may be determined based on the speed at which N×1 mux operations in the switch network 270 can be switched, a recovery time for the photon sources 252 and/or the detectors 254, the operating speed of circuits downstream of the switch network 270, or other design considerations to allow each time bin to be treated as an independent temporal mode.

As noted above, the behavior of the photon sources 252 may be non-deterministic. For example, during a given time bin, the probability of a photon being generated by a given photon source 252 may be represented as pₛ, where pₛ<1. For photon sources of this type, multiplexing as shown in FIG. 2B provides the ability to increase the probability of successfully producing a photon in a given time bin. As shown in FIG. 2B, if N non-deterministic single-photon sources are used, with one photon source coupled to each input of the switch network 270, and if each photon source has probability pₛ of generating a photon (for a given time bin), then the probability that the switch network 270 receives at least one photon is pₘₐₓ=1−(1−pₛ)\hat{ }N. Thus, for a given type of photon source 252, a desired probability Pₘₐₓ of providing one photon per time bin to the output waveguide 286 may be achieved by a suitable choice of N. Although it is appreciated, as a practical matter, some combinations of pₛ and pₘₐₓ may require a prohibitively large number N of photon sources.

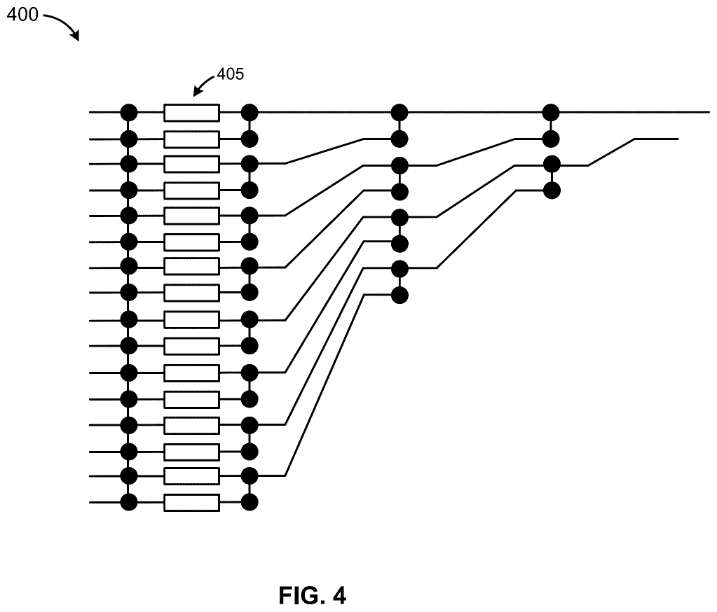

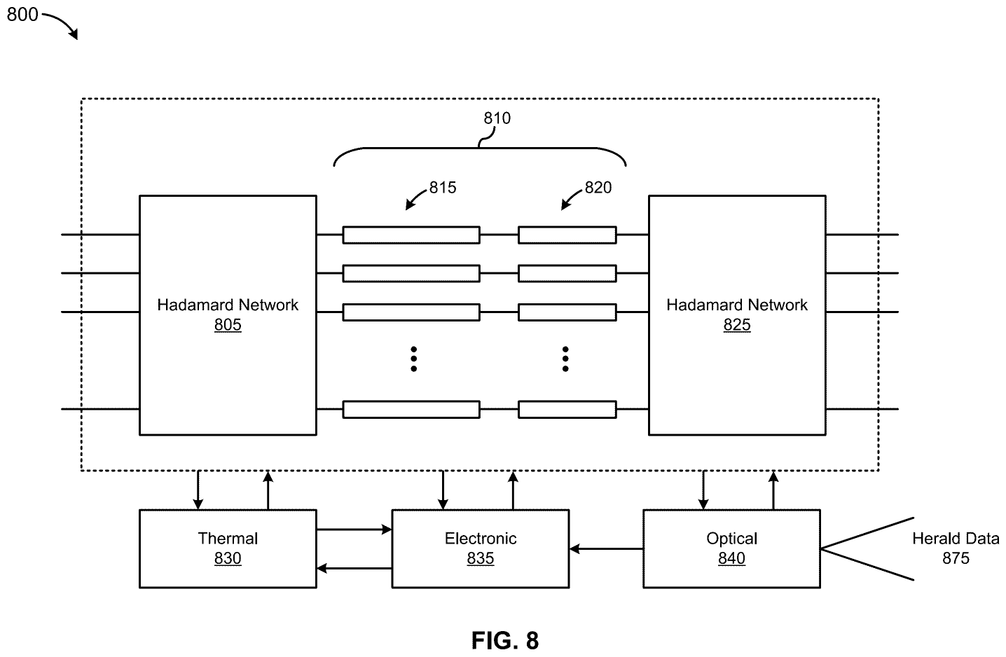

FIG. 2C shows an example of a single photon source photonic integrated circuit (PIC) 290, in accordance with some embodiments. The embodiment of FIG. 2C is an example of a single chip that implements the source architecture 250 of FIG. 2D as discussed above. FIG. 2D shows an example fabrication stack that may be implemented to fabricate the different components shown in the single photon source photonic integrated circuit 290 using existing semiconductor fabrication processes, in accordance with some embodiments. As illustrated in FIG. 2C, the PIC 290 comprises a photon source array 291 that generates photons non-deterministically. In some embodiments, each source in the photon source array 291 comprises a ring resonator and a MZI where an upper portion of the ring resonator functions as the lower arm of the MZI. In some embodiments, each source in the photon source array 291 receives pump light and implements one or more single photon source schemes (e.g., spontaneous four wave mixing, spontaneous parametric down conversion) to non-deterministically generate single photons. In some embodiments, each source in the array comprises a single input and a single output that is coupled to a filter. Each source outputs the pump light and one or more photon pairs into a filter array 292 for filtering. In some embodiments, each filter in the filter array 292 is configured as a pump rejection filter to filter out pump light such that only photon pairs are outputted from the filter array 292. In some embodiments, one of the photons from each filter impinges on a herald detector to indicate that its counterpart photon (e.g., signal photon) exists and is propagating towards the switch 293 (e.g., a quantum MZI 400 in FIG. 4 or the quantum GMZI switch architecture 800 in FIG. 8). As discussed in further detail below, the switch 293 may include a first quantum optical coupler network 294 (e.g., a Hadamard network) that separates the quantum light onto a plurality of waveguide arms and a second quantum optical coupler network 296 that combines the quantum light in such a way (e.g., via interference) that the quantum light is outputted from a single output waveguide 298 (e.g., a photon 297). In some embodiments, the switch 293 comprises electro-optical material (e.g., BTO, discussed below) that can change the phase of the light on one or more of the given arms to implement a N-to-1 permutation, as discussed in further detail below.

FIG. 2D illustrates an example fabrication stack of a PIC wafer 2400 including various photonic integrated circuit components according to certain embodiments. In the illustrated example, PIC wafer 2400 includes a substrate 2402, buried oxide (BOX) layer 2404, a temperature sensor 2406, a grating coupler 2408, a ridge waveguide 2410, a heater 2412, a Ge photodiode 2414, one or more layers of SiN waveguides 2415 and 2416, one or more superconducting nanowire single photon detectors (SNSPDs) 2418 (e.g., a herald detector 299 in FIG. 2B), and SNSPD contact regions 2420. As described above, the silicon-based circuit components, such as grating coupler 2408, a ridge waveguide 2410, temperature sensor 2406, and the like, may be formed in a silicon on insulator (SOI) layer deposited on the BOX layer 2404. The SiN waveguides 2415 and 2416 may have different thicknesses and different losses, and may be used to form various active and passive photonic integrated circuit components, such as delay lines, phase shifters, ring oscillator, interferometers, switches, filters, and single photon detectors, couplers. The SiN waveguides 2415 and 2416 may receive light from an optical fiber through edge coupling or a grating coupler 2408.

A heater 2412 may include, for example, a silicide layer (such as a nickel silicide layer), a nitride layer (e.g., TiN or NbN), or another resistive material layer, and may be used to tune silicon waveguides. The silicide layer may also be formed in other regions, such as on top of a silicon material region in the SOI layer below a SNSPD 2418, to form part of a scatter mitigation structure. The wafer with these devices and structures may be bonded with a wafer with phase shifters 2422 (e.g., an electro-optical material 295 in FIG. 2C) for BTO switches formed thereon. The substrate of the wafer with the phase shifters 2422 may subsequently be removed and the strontium titanate (SrTiO3, STO) layer of the phase shifters 2422 may be patterned by selective etching.

Electrical contacts 2424 (e.g., through-oxide vias) may be formed in the oxide layers to make electrical connections to the various devices, such as a heater 2412, a Ge photodiode 2414, SNSPDs 2418 and phase shifters 2422. As illustrated in the example, electrical contacts 2424 may include metal trenches surrounding the SNSPDs 2418 to form scatter mitigation structures for blocking stray light as described above.

As also illustrated in FIG. 2D, thermal trenches 2426 and undercut regions 2428 may be formed in the oxide layers and substrate 2402 respectively. Additionally, or alternatively, thermal isolation trenches 2430 and undercut region 2432 may be formed by, for example, etching trenches in the oxide layers to expose certain regions of the SOI layer, and then selectively etching the SOI layer to remove the silicon and form an undercut region. In some embodiments, other structures, such as metal trenches 2434 are formed in the oxide layers and the substrate.

After these structures are manufactured, a PIC wafer 2400 may be processed using the back-end-of-line (BEOL) processes to form one or more metal layers 2436 and vias 2438 (e.g., metal plugs or metal trenches). Some of the vias 2438 may be aligned with some of the electrical contacts 2424 to form the scatter mitigation structures for SNSPDs 2418. In some embodiments, a trench 2440 aligned with a grating coupler 2408 may be etched in the oxide layer to facilitate the coupling of light into the waveguides. For example, an optical fiber may be inserted into the trench 2440 or positioned on the trench 2440 to send light to the grating coupler 2408.

As illustrated in FIG. 2D, one or more etch stop layers 2442 (e.g., SiCN layers) may be used as needed for etching and patterning the metal layers and other structures. The SiCN layers may also be passivation layers for the metal (e.g., copper) in the metal layers. Contact pads 2450 may be formed on the top metal layer (bottom layer shown in FIG. 2D) of PIC wafer 2400. In the illustrated example, trenches 2460 may be etched to form boning balls (not shown in FIG. 2D) for bonding contact pads 2450 with an electronic integrated circuit (EIC) wafer.

The PIC wafer 2400 shown in FIG. 2D includes various passive and active photonic components in a same wafer stack, such as silicon waveguides, SiN waveguides that form parts of other passive or active photonic components (e.g., splitters, filters, delay lines, phase shifters, and single photon sources), grating couplers, Ge photodetectors, single photon detectors, low power BaTiO3 (BTO) phase shifters/switches, temperature sensors, and heaters. Thus, the PIC wafer 2400 may be used to perform various functions for optical quantum computing, such as single photon generation, photon entanglement, fusion, qubit storage, resource state generation, single-photon and multi-photon measurement, and data communication. The PIC wafer 2400 also includes thermal isolation structures (e.g., undercut regions 2428 and trenches 2426) for thermally isolating, for example, the heaters from other components. The undercut regions 2428 may be formed in a large region in a substrate 2402 to thermally isolate components in a large region. Undercut regions (e.g., the undercut region 2432) may additionally or alternatively be formed in an SOI layer. The PIC wafer 2400 further includes scattered light mitigation structures formed by metal layers, a silicide layer, and through-oxide vias or trenches, to isolate, for example, the single photon detectors from stray light.

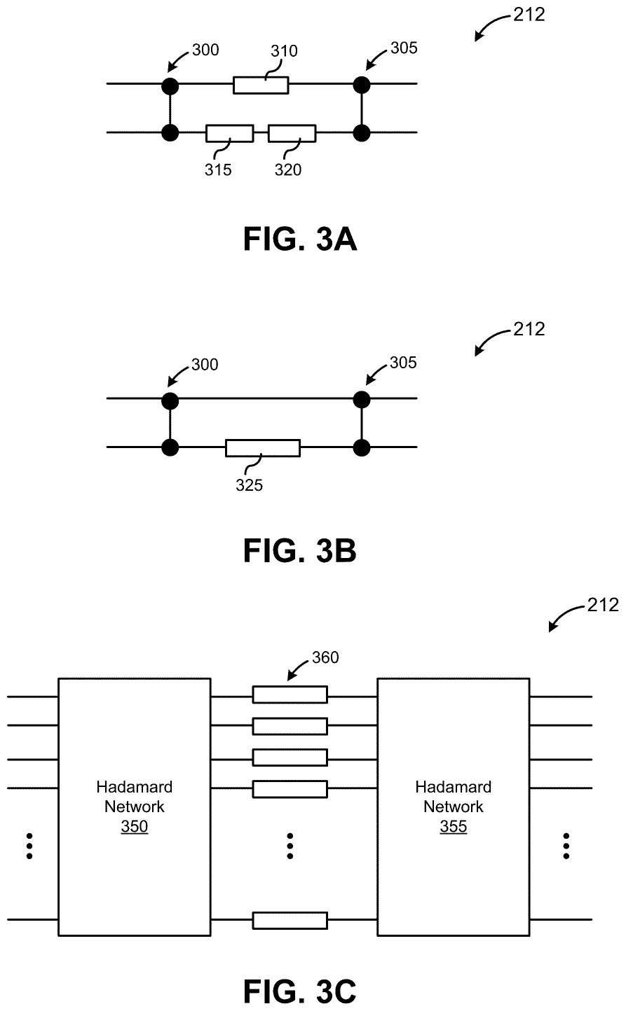

The following are embodiments of MZI based switches, in accordance with some embodiments. In particular, for example, FIG. 3A-3B show implementations of the optical switch 212 configured as an MZI in the first switch network 210 and the second switch network 225, in accordance with some embodiments. It is appreciated that each switch in the first switch network 210 and the second switch network 225 may each be implemented as an individual MZI illustrated in FIGS. 3A-3C and as further discussed in further detail below.

A Mach-Zehnder Interferometer is a network that may be configured to apply identity or swap operations on two inputs. For example, to switch between transfer matrices which are pairs of Pauli operations using active phase shifters:

$$I or X = h ( I or Z ) h = {Sh}_{c} ( Z or I ) {h}_{c} S$$

$$I or Y = Sh ( I or Z ) {hS}^{†} = {Zh}_{c} ( Z or I ) {h}_{c}$$

$$where h = ( \begin{matrix}1 & 1 \\ 1 & - 1\end{matrix} ) / \sqrt{2} , {h}_{c} = ( \begin{matrix}1 & - i \\ - i & 1\end{matrix} ) / \sqrt{2} , and X = ( \begin{matrix}0 & 1 \\ 1 & 0\end{matrix} ) , Y = ( \begin{matrix}0 & - i \\ i & 0\end{matrix} ) , Z = ( \begin{matrix}1 & 0 \\ 0 & i\end{matrix} ) .$$

FIG. 3A shows an example in which the phase shifters implement −iI/Z and FIG. 3B shows an example quantum GMZI 400 in which the phase shifters implement I/Z, in accordance with some embodiments. With reference to FIG. 3A, the optical switch 212 (e.g., an MZI) comprises a first splitter 300 (e.g., beam splitter, half silver mirrors, directional coupler, a multimode interference (MMI) waveguide, a cross coupler or “star” coupler) and a second splitter 305 (e.g., beam splitter, crystal, half silvered mirror, directional coupler, MMI) that separate the light (e.g., bright light, single photon) onto a top arm and bottom arm and then recombine the light for output on one or both output ports. In the example of FIG. 3A, the top arm comprises an active phase shifter 310 and the bottom arm comprises an active phase shifter 315. Further, the bottom arm comprises a further fixed passive phase shifter 320.

In FIG. 3B, the optical switch 212 comprises the first splitter 300 and the second splitter 305 that separate the light onto the top and bottom arms and then recombine the light for output on one or output ports. Further, in the example of FIG. 3B, MZI comprises a single active phase shifter 325 on the bottom arm to implement I phase shifts.

FIG. 3C illustrates the optical switch 212 implemented as a generalized MZI (GMZI), in accordance with some embodiments. The GMZI is an extension of an MZI with N>2 inputs and M≥1 outputs, shown in FIG. 3C. This configuration allows a set of permutations to be performed on the inputs, thereby configuring the switch as a useful block in the design and construction of composite N-to-1 and N-to-M switch networks. In some embodiments, varying the settings of phase shifters 360 (e.g., active phase shifters) sets specific permutations of the N inputs and routes them to M>1 output ports. There are a number of spatial mux schemes that select one of multiple inputs from distinct locations in space. For example, a GMZI can be configured as a N-to-1 mux, as it allows routing of any input to a single output port. The advantages of this scheme include low constant active phase shifter depth (e.g., depth=1) and low N count. However, the total propagation distance and the number of waveguide crossings increase rapidly with N.

As illustrated in FIG. 3C, the example GMZI comprises a first Hadamard network 350 or splitter (e.g., etalon, an MMI, a network of directional couplers and waveguide crossings) and a second Hadamard network 355 or splitter (e.g., etalon, an MMI, a network of directional couplers and waveguide crossings) that split and recombine the light propagating on one or more of a plurality of arms (e.g., eight arms, in an 8×8 GMZI) such that the light is outputted on one or more of the plurality of output ports. Example architecture for the first Hadamard network 350 and second Hadamard network 355 are discussed in further detail below.

In a bright light example, the GMZI can operate as a power splitter that splits the beam onto the output ports in a given configuration according to settings of the phase shifters 360. In the single photon quantum light operation, the GMZI splits superpositions of the quantum light onto the output ports for recombination and output according to settings of the phase shifters 360.

FIG. 4 shows an example quantum GMZI 400 configured as a N-to-1 multiplexer configuration that implements a plurality of phase shifters 405, in accordance with some embodiments. The quantum MZI 400 is an example configuration that can collect light (e.g., bright light, quantum light, single photons) from a plurality of optical sources 205 that generate the light with a probabilistically low occurrence to output a single muxed source of light (e.g., muxed quantum light) with a probabilistically higher occurrence. The configuration of the quantum MZI 400 is an example of the optical switch 212 that is implemented in the first switch network 210.

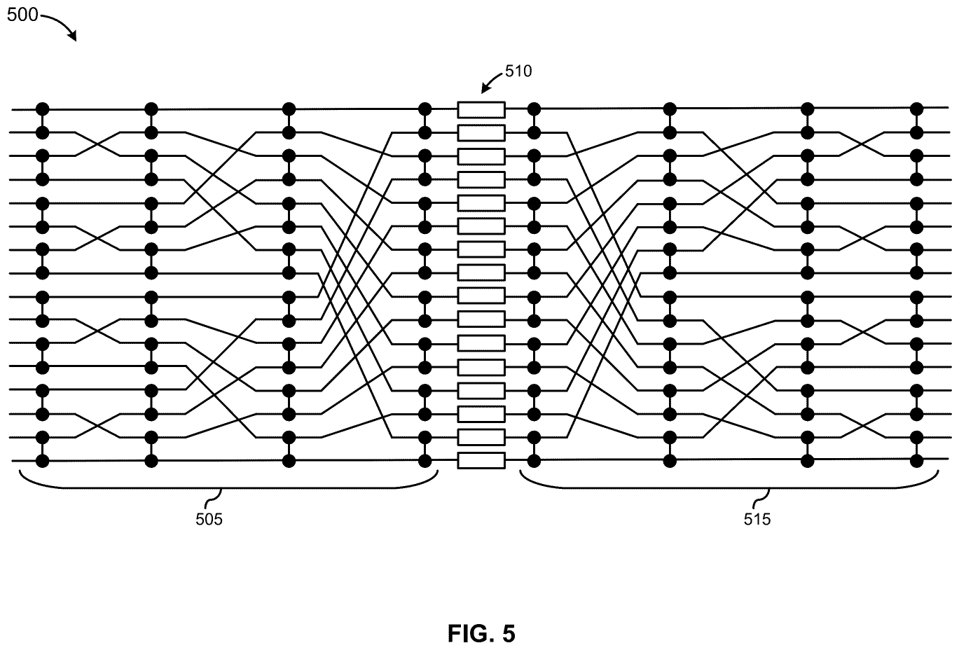

FIG. 5 shows an example linear-optical quantum generalized MZI 500 in a 16×16 configuration, in accordance with some embodiments. The coupler network 505 corresponds to the first Hadamard network 350 and the coupler network 515 corresponds to the second Hadamard network 355, which together function as 16-mode Hadamard quantum optical coupler network. In some embodiments the plurality of phase shifters 510 are implemented as fast phase shifters that can be set from zero to π shifts to select one of 16 operations (e.g., G([2, 2, 2, 2]). In some embodiments, each phase shifter on each arm comprises two-phase shifter, such as a fast phase shifter (e.g., switching phase shifter) and a slow phase shifter (e.g., trim phase shifter), as discussed in further detail below with reference to FIG. 8.

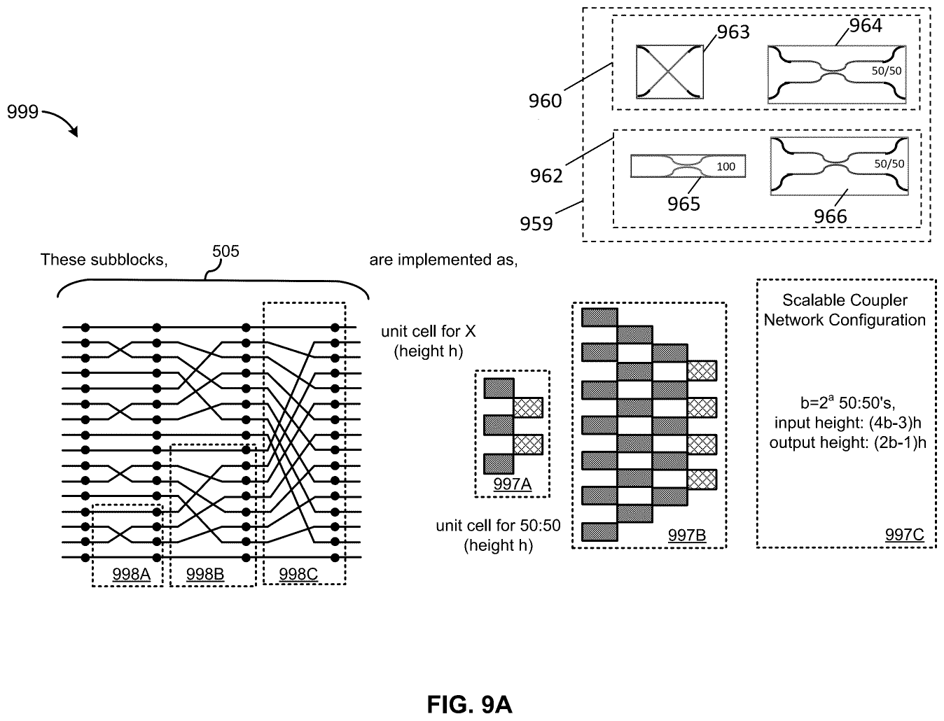

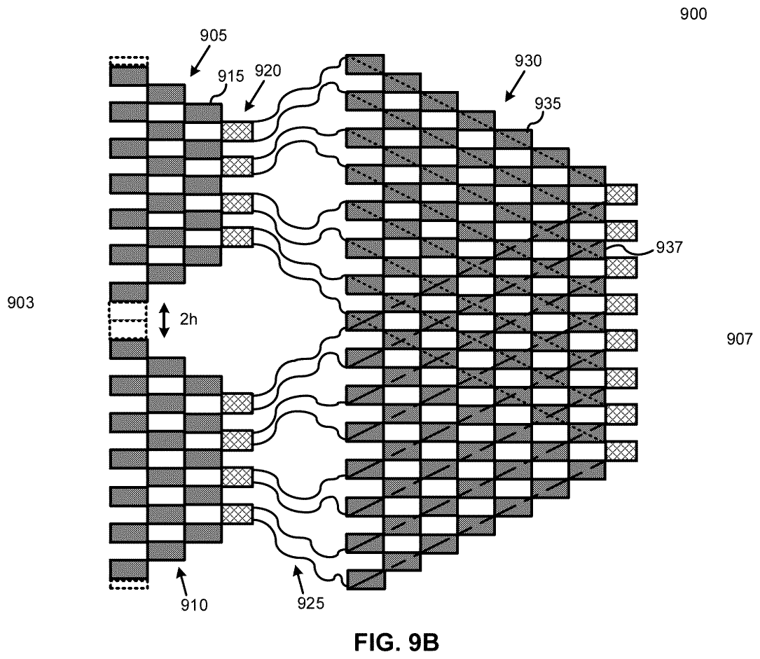

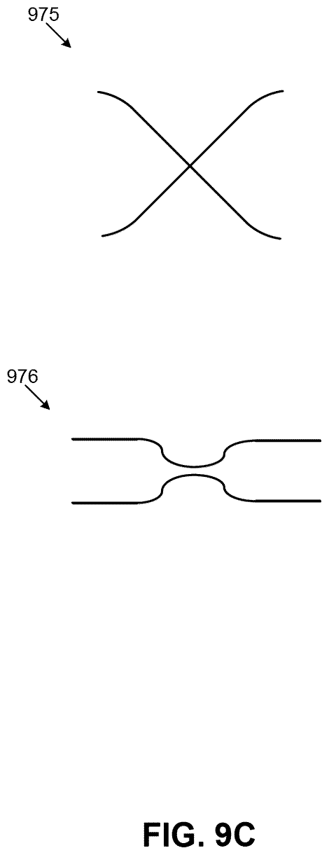

Example architectures for the coupler network 505 and the coupler network 515 are discussed in in further detail below with reference to FIGS. 9-14B. The quantum GMZI 500 is an example optical switch that may process quantum light to generate entanglements in the photonic entanglement circuit 220, generate clustered entanglements in the second switch network 225, in accordance with some embodiments. Further, the MZI is an example optical switch that may be used to route quantum light by configuring the phase shifters 510 in different permutations.

Analytically, the GMZI architectures, such as the quantum MZI 400, the quantum GMZI 500, the quantum GMZI architecture 600, and the quantum GMZI switch architecture 800, are configured to function as a switch network that implements a set of unitary transfer matrices Uₖ, where each unitary routes light between a subset of input and output ports. As an example, if Uₖ is set to route light from port t to port s, then its s^{th} row and t^{th} column are set to zero apart from |U_{s,t}|=1, and similarly for other pairings of input and output ports. The following elucidates example sets of routing operations of a photonic GMZI switch-based information processing architecture, in accordance with some embodiments. In some embodiments, the photonic GMZI switch-based information processing architecture is configured as a scalable waveguide-based switching network that implements transfer matrices using interferometer gates and phase shifters. In some embodiments, the transfer matrices are of the form: Uₖ=W Dₖ V^{†}, where the unitary matrices W, V describe passive interferometers (e.g., the first Hadamard network 350 and the second Hadamard network 355 in FIG. 3), and the Dₖ form a set of diagonal phase matrices (e.g., phases applied to the phase shifters 360, the phase shifters 615, or pairs in the waveguide arm phase shifters 810). In some embodiments, the phase matrices are implemented physically using a single layer of fast phase shifters acting on every waveguide arm (e.g., the phase shifters 615 in FIG. 6 or the fast phase shifters 815 in FIG. 8). In some embodiments, the slow phase shifters are used to zero out a given photonic device.

In the following the phase matrix D implemented in terms of a phase vector d, Dₛ=dₛδ_{s,t} for simplicity. In some embodiments, the photonic GMZI switch-based information processing architecture is configured to function as a scalable switch network that implements different sets of permutation matrices Uₖ=W Dₖ V^{†}, according to desired routing configurations (e.g., to implement a given algorithm or instructions in memory 104, generate entangled states, or perform error correction). By adding the fixed passive network (e.g., a Hadamard network) corresponding to e.g., U⁻¹ (e.g., the inverse of an arbitrary permutation from that set) a new set of pairwise commuting permutation matrices: {U_k U_1\hat{ }(−1)}=W [symbol] D\hat{ }′ [symbol] _(k) W\hat{ }+†} may be generated. At a high level, and in accordance with some embodiments, the photonic GMZI switch-based information processing architecture is configured as a switch network where {U_k U_1\hat{ }(−1)}={W Dₖ W^{†}†} is a set of transfer matrices corresponding to commuting permutations of N waveguide arms or modes (e.g., N=4 in FIG. 8) for a given switch network configuration. The individual phase shifter settings in Dₖ correspond to given roots of unity (e.g., up to an overall global phase factor e^{iφk} which can be chosen at will). Further, the photonic GMZI switch-based information processing architecture implements one or more GMZI switches with a switch setting Dₖ to route light from input port 1 to output port k.

The embodiments below illustrate example linear-optical photonic circuit GMZI architectures to implement different routing operations G([n₁, n₂, . . . , nᵣ]) on waveguide arms N=Πₗ₌ₗ^{r}nₗ:

$${P}_{k} = {( {c}^{( {n}_{1} )} )}^{{k}_{1}} ⊗ {( {C}^{( {n}_{2} )} )}^{{k}_{2}} ⊗ … ⊗ {( {C}^{( {n}_{r} )} )}^{{k}_{r}}$$

with settings vector k where 0≤kₗ<n with l=1, . . . , r, and further where the transfer matrices W Dₖ W^{†} are as follows:

$$W = {W}^{( {n}_{1} )} ⊗ {W}^{( {n}_{2} )} ⊗ … ⊗ {W}^{( {n}_{r} )} {with ( {W}^{( {n}_{l} )} )}_{s , t} = \frac{{e}^{≀ 2 πst / {n}_{l}}}{\sqrt{{n}_{l}}} ,$$

In the above transfer matrices, the Wⁿ^{ₗ} are discrete Fourier transform (DFT) matrices and the k^{th} setting of the fast phase shifters are set by:

$${D}_{k} = {D}_{𝓀}^{( {n}_{1} )} ⊗ {D}_{{𝓀}_{2}}^{( {n}_{2} )} ⊗ … ⊗ {D}_{{𝓀}_{r}}^{( {n}_{r} )} , with {( {d}_{𝓀}^{( n )} )}_{s} = {e}^{- i 2 π 𝓀s / n} for {D}_{𝓀}^{( n )}$$

In some embodiments, scalable networks of GMZI switches are implemented to a large number of modes or waveguide arms, N, with log-depth stages of interference using the following decomposition:

$$\begin{matrix}W = ( {W}^{( {n}_{1} )} ⊗ {I}^{( N / {n}_{1} )} ) ( {I}^{( {n}_{1} )} ⊗ {W}^{( {n}_{2} )} ⊗ {I}^{( N / ( {n}_{1} {n}_{2} )} ) … ( {I}^{( N / {n}_{r} )} ⊗ {W}^{( {n}_{r} )} ) \\ = ( {S}_{N / {n}_{1} , {n}_{1}} {I}^{( N / {n}_{1} )} ⊗ {W}^{( {n}_{1} )} {S}_{N / {n}_{1} , {n}_{1}}^{d} ) ( {I}^{( {n}_{1} )} ⊗ {S}_{N / ( {n}_{1} {n}_{2} ) , {n}_{2}} {I}^{( N / {n}_{2} )} ⊗ {W}^{( {n}_{2} )} {I}^{( {n}_{1} )} ⊗ {S}_{N / ( {n}_{1} {n}_{2} ) , {n}_{2}}^{t} ) … ( {I}^{N / {n}_{r} )} ⊗ {W}^{( {n}_{r} )} )\end{matrix}$$

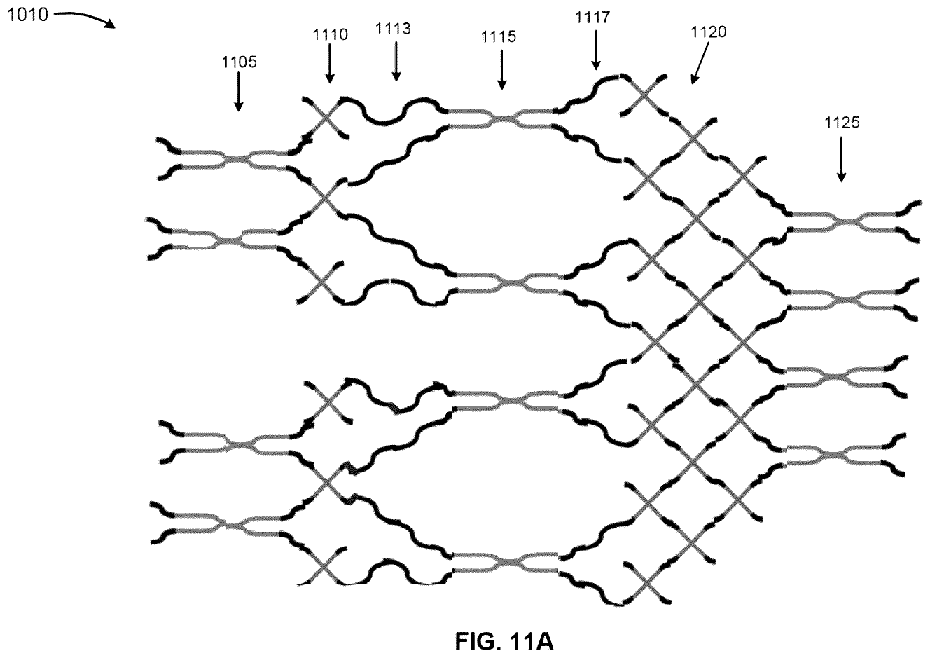

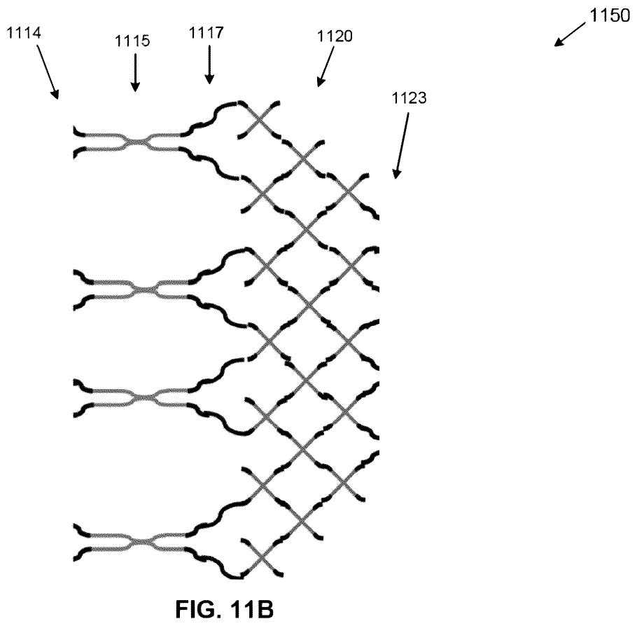

In the above decomposition, the matrices S., correspond to crossing networks (e.g., the crossing network 1120 in FIG. 11B) which reorder modes in waveguides in the GMZI. In some embodiments, the subexpressions of the form

$${I}^{( N / nl )} {I}^{( \frac{N}{{n}_{l}} )} ⊗ {W}^{{n}_{l}}$$

correspond to repeated blocks of modes interfering according to unitary Wⁿ^{ₗ} in the above decomposition, and thus function as stages of local interference separated by crossing networks, such as the crossing network 1120 in FIG. 11B. Further, FIG. 5, discussed above, illustrates an example of Hadamard GMZI implementing the decomposition (e.g., N-to-M permutation), and FIG. 4 illustrates an example of the Hadamard GMZI implementing the GMZI as a simplified N-to-1 mux.

In some embodiments, additional GMZI architectures are implemented by decomposing the unitary matrices W″t that set the design of beam-splitter operations (e.g., the Hadamard network 350 or the second Hadamard network 355) and phase-shifter operations (e.g., the phase shifter 615 or the phase shifter set 810). It is appreciated that the optical depth of networks constructed using the recursive decomposition is reliant on high-precision optical hardware and very low optical loss, as the depth of the crossing networks must be accounted for in addition to the stages of local interference (e.g., the depth in crossings of the largest crossing network scales with N/2-1).

FIG. 6A shows an example quantum GMZI architecture 600 in accordance with some embodiments. In the example of FIG. 6, a plurality of waveguide arms input light (e.g., classical light, quantum light) into a first Hadamard network 610. The output light from the first Hadamard network 610 is then phase shifted by a plurality of phase shifters 615 and input into a second Hadamard network 620. In the example configuration of an architecture 600, a single layer of the phase shifters 615 are implemented to perform phase-shift-based light mixing (e.g., bright light mixing, quantum-light probability-distribution adjustments). In some example embodiments, the phase shifts applied comprise 0 to π phase shifts and zero to 2π phase shifts. In some embodiments, the phase shifters are operated in an “in-between” phase-shifter configuration to act an array of beam splitters. In these in-between configuration embodiments, light is input into two target input waveguide arms and can be interfered with 50% of the light transmitted to a given output port where the measurement is made (e.g., via photodetector). In some embodiments, a set of phase shifters are implemented on each arm, as discussed in further detail below with reference to FIG. 8.

Continuing, with reference to FIG. 6 and in accordance with some embodiments, the light adjusted by the second Hadamard network 620 is outputted from the second Hadamard network 620 (e.g., from the right side of the second Hadamard network 620 in the perspective view of FIG. 6A) to one or more detectors 625. Although the example of FIG. 6A shows eight waveguide arms (e.g., cight modes, N=8), it is appreciated that in other embodiments other numbers of waveguide arms may be implemented in a similar manner.

In some embodiments, the one or more detectors 625 are single-photon detectors (e.g., photo-number-resolving detectors) that detect a single photon of light as the photon exits the second Hadamard network 620. In some embodiments, the photo detectors are bright-light detectors (e.g., phototransistors, photodiodes) that are implemented to detect bright light that is power split onto the plurality of outputs of the second Hadamard network 620. For example, in some embodiments, bright light is injected into one of the input ports of the second Hadamard network 620 and is detected from one of the output ports of the second Hadamard network 620, wherein calibration of the phase shifters 615 are calibrated by modifying the phase shift settings until the phase difference between the input light and the output light is minimized or zeroed out. In some embodiments, a portion of the output bright light is tapped to from the output waveguides of the second Hadamard network 620 to perform the bright-light-based adjustments and once adjusted, the architecture is configured in quantum light mode whereby single photon detectors (e.g., avalanche photodiodes, photon number resolving detectors, superconducting nanowire detectors) are implemented as the detectors 625 to detect quantum light (e.g., single photons) outputted by the quantum GMZI architecture 600. In some embodiments, once the plurality of phase shifters 615 are zeroed out using bright light, the quantum GMZI architecture 600 is operated in nonclassical quantum light mode, in which single photons or entangled photon groups are propagated through the quantum GMZI architecture 600, and the plurality of phase shifters implement zero to it phase shifters on the superposition of the single photon in the arms of the quantum GMZI architecture 600 to modify probabilities of the quantum light existing from one or more of the output ports (e.g., right side ports) of the second Hadamard network 620.

In some embodiments, the waveguides of the plurality of arms in the quantum GMZI architecture 600 are designed and fabricated to minimize loss as the respective arms propagate classical or quantum light in the quantum GMZI architecture 600. For example, the waveguides are configured in a fan-in configuration 605 to couple light from multiple larger separate light sources (e.g., the plurality of optical sources 205) into the smaller input interface of the first Hadamard network 610. Further, the waveguides may be configured in a fan-out architecture 613 to connect the waveguides to the plurality of phase shifters 615 without incurring significant optical loss which can affect quantum light processing (e.g., cause decoherence). Further, the waveguides may be configured in a fan-in architecture 617 into the second Hadamard network 620 and/or a fan-out configuration 618 to couple to additional devices, such as other switches, further waveguide routing, fiber interfaces, or light detectors (e.g., photodetectors, photodiodes, or the detectors 625).

FIG. 6B shows a passive quantum GMZI architecture 650 that implements passive phase shifts, in accordance with some embodiments. In contrast to FIG. 6A, the passive quantum GMZI architecture 650 in FIG. 6B does not implement active phase shifters and instead performs the desired phase shifts using a plurality of top arm waveguides (e.g., fixed passive phase shifters) 685 and a plurality of bottom arm waveguides 675 that have a shape to affect the waveguide length and thereby change the phase of the light traversing the waveguides. In some embodiments, the passive phase shifts in the top arm waveguides (e.g., fixed passive phase shifters) 685 are performed by adding an additional length, ΔL, which is configured to implement a free spectral range that is less than the subcomponents of the Hadamard gates (e.g., the first Hadamard network 610, the second Hadamard network 620). In some embodiments, the phase shift for GMZI architecture 650 is defined as n2RΔL/λ. In the passive quantum GMZI architecture 650, the wavelength sweep at the input ports may generate a phase shift change across several 2× to enable extinction ratio and measurement of the first Hadamard network 610 and the second Hadamard network 620. In some embodiments, the routing of the passive quantum GMZI architecture 650 is dependent on whether the first Hadamard network 610 and the second Hadamard network 620 are configured the same or differently (e.g., to implement different unitary operations comprising real transpose or complex conjugation operations). In the example illustrated, the bottom arm waveguides 675 are configured in a log-tree waveguide fan-out and fan-in with straight waveguides to avoid phase differences between the different arms in the bottom arm waveguides 675. Further details of the log-tree fan out and fan-in configuration are discussed with reference to FIG. 7.

FIG. 7 shows an example waveguide fan architecture 700 that may fan-in or fan-out light without incurring significant loss in accordance with some embodiments. In some embodiments, the input pitch, wᵢₙ, is the orientation of the input waveguides and the output pitch, wₒᵤₜ, is the pitch orientation of the waveguide outputs. The inputs and outputs may be connected using segments configured in s-bends (e.g., Euler bends). For example, where the input pitch is smaller and the output pitch is larger (e.g., as in a fan-out configuration), the waveguide fan architecture 700 is configured as a log-tree fanout with segments (e.g., Euler bends, clothoid curves, Euler spiral) of heights, 8 s, 4 s, 2 s, 1 s, where s=wᵢₙ−wₒᵤₜ/2, where the wᵢₙ has a height of h, and the wₒᵤₜ has a height of 2 h, in accordance with some embodiments.

FIG. 8 shows a quantum GMZI switch architecture 800, in accordance with some embodiments. As illustrated, light is input into a first Hadamard network 805 (e.g., a first Hadamard gate) and phase shifted by the waveguide arm phase shifters 810. In some embodiments, each phase shifter may be implemented by active optical components built by optical waveguides, such as an electrooptical phase shifter comprising an optical waveguide that is combined with electro-optical materials and electrodes. The optical waveguide of the phase shifter may be fabricated from different materials, including silicon, silicon nitride, doped SiO2, a complex oxide (e.g., lithium niobate, barium titanate), or III-V materials.

In some embodiments, the phase shifter operates by applying an electrical signal to the electro-optical material to change its index of refraction and thereby shift the phase of the light propagating in the waveguide. In some embodiments, the application of the electrical signal to the electro-optical material causes a phase shift from plasma dispersion effects in silicon and III-V semiconductors. In some embodiments, the electrical signaling is applied to control a Pockels effect in the shifter (e.g., as in Lithium Niobate and Barium Titanate), or cause Kerr effects. In some embodiments, the active material is resistive and thermal-optical effects cause phase shifts in the propagating light.

In some embodiments, the electrical signaling is applied via electrodes in the phase shifter, where electrodes include different conductive contacts and conductive traces (e.g., metals such as Cu, Al, Au).

In some embodiments, the pitch of the phase-shifter array is increased by fanning out optical waveguides between the Hadamard network gates and the plurality of phase shifters thereby reducing undesired cross-couplings between the separate phase shifters (e.g., minimize thermal or piezo-electric couplings). In some embodiments, the phase shifters are implemented as fast phase shifters and slow phase shifters (e.g., heaters or MEMS switches configured as a phase shifter).

Continuing with reference to FIG. 8, after shifting by the waveguide arm phase shifters 810, the light is then further processed by a second Hadamard network (e.g., the second Hadamard network 825) and output from a plurality of output ports (e.g., to further switches or detectors) of the photonic processing architecture 200. In some embodiments, the components of the quantum GMZI switch architecture 800 are fabricated in a single photonic integrated circuit (e.g., on a single substrate) and the components are interconnected using integrated waveguides (e.g., silicon waveguides, silicon nitride waveguides).

Switching operations: In some embodiments, light (e.g., photons) is inputted into any of the N-input ports (e.g., left side ports of the first Hadamard network 805) and are switched to any of the N-output ports (e.g., right side of the second Hadamard network 825). As discussed, the switching operations may be implemented by the waveguide arm phase shifters 810 including the fast phase shifters 815 and the slow phase shifters 820. In some embodiments, the slow phase shifters are driven by a control system (e.g., the controller 107A, the controller 107B, instructions issued from the classical computer system 103, the microprocessor system, ASIC, or the electrical integrated logic circuit). In some embodiments, the control system comprises a plurality of control subsystems comprising a thermal controller 830, an electrical controller 835, and an optical controller 840. In some embodiments, the optical controller 840 receives herald data 875 and adjusts operation of the quantum GMZI switch architecture 800 based on the received herald data 875. Although the thermal controller 830, the electrical controller 835, and the optical controller 840 are illustrated as external to the quantum GMZI for explanation and clarity purposes, it is appreciated that components of the thermal controller 830, the electrical controller 835, the optical controller 840—such as sensors, waveguides and electrical traces may be integrated throughout the GMZI to detect and control different components.

At a high level, and in accordance with some embodiments, the electrical controller 835 controls the slow phase shifters (e.g., sets biases) to tune and zero out the architecture (e.g., the quantum GMZI switch architecture 800, the photonic processing architecture 200), and the electrical controller 835 controls the fast phase shifters to finish switching operations (e.g., 0 to n phase shifts to implement transform matrices or dynamic updates for error correction). In some example embodiments, the electrical controller 835 receives herald data from a plurality of single photon sources (e.g., pair source generators where the signal photon is detected, and the idler photon is further propagated to the quantum GMZI switch architecture 800. In some example embodiments, in response to receiving electrical herald data that a photon is being input on one of the arms of quantum GMZI switch architecture 800, the electrical controller 835 retrieves phase shifter data from a memory (e.g., look up table having phase shifter settings determined from the transfer matrices) and applies the phase shifter settings to the fast phase shifters 815 at runtime (e.g., during routing of photons for processing of quantum information tasks). As used here, the fast phase shifters generally function as the switching phase shifters that can complete phase shifts more quickly than the slow phase shifters (e.g., heaters). In some example embodiments, both the sets of phase shifters are fast phase shifters that have approximately same shifting speed, wherein one of the phase shifters is used for trimming (e.g., setting phase from 0 to 2Pi) and the other of the phase shifter on the same arm is used for high-speed switching during operation (e.g., for single photon muxing).

In some embodiments, during operation, the performance of the fast phase shifters 815 and/or the slow phase shifters 820 may drift or degrade with time. The optical controller 840 may be configured to detect the optical signal (e.g., from bright light or single photon detectors, detecting a herald photon via the herald detector 299 in FIG. 2C) and provide feedback to the electrical controller 835. The electrical controller 835 may then adjust the phase shifter driving signals in the control circuits and the drivers to configure (e.g., bias) the phase shifters to compensate for the drifts or performance degradation.

In some embodiments, the phase shifters are sensitive to local temperature gradient of the environment in which the quantum GMZI switch architecture 800 operates. In some embodiments, throughout the operation, the temperature sensors in the thermal controller 830 monitors the temperature at different locations of the quantum GMZI switch architecture 800 (e.g., the local temperatures of each phase shifter in the waveguide arm phase shifters 810 or the local temperatures of the first Hadamard network 805 and the second Hadamard network 825). The temperature sensors provide the feedback to the control circuits in the electrical controller 835. If the local temperature needs to be adjusted, the control circuits of the electrical controller 835 comprise logic or instructions to send signals to the heaters in the thermal controller 830 to cause the heaters to heat up the GMZI locally.

In some embodiments, the electrical controller 835 is implemented by electronic integrated circuits comprising logic to implement controls. The integrated circuits may include analog circuits and digital circuits such as high-speed phase shifter drivers, biasing network circuits, monitoring and control circuits. The electronic integrated circuits may be manufactured by different platforms, such as CMOS, SiGe, III-V. In some embodiments, large output extinction ratio are enabled via precise control over phase-shifts in each arm. In some embodiments, the precise control is implemented via programmable DACS that control voltage levels for the slow and fast phase shifters, as well as feedback control for thermal regulation. In some embodiments, schemes such as pre-emphasis and close electrical proximity of driver circuits are implemented by the electrical controller 835 to perform optimization and achieve precise voltage settings for the settings of the fast phase shifters 815.

In some embodiments, the optical controller 840 comprises optical waveguide devices, photodetectors (e.g., bright light photodetectors, monitor photodiodes, single photon detectors) and tapping components (e.g., optical taps or switches configured to activate and tap light from a given waveguide). In some embodiments, the bright-light photodetectors of the optical controller 840 are formed from materials including one or more of: doped silicon, germanium, or superconducting materials. In some embodiments, upon the optical signal being detected by one or more of the photodetectors, electrical signal is then generated from the optical signal and transmitted to the electrical controller 835 for control signal processing.

In some embodiments, the thermal controller 830 comprises a plurality of temperature sensors that detect temperature. For example, the temperature sensors (e.g., thermometers) can be implemented by sensing the electrical signals of different materials, such as DLTM (e.g. doped Si), metals (e.g. Al, Cu, W, TiN, etc.), and dielectric materials (e.g. Barium Titanate). When temperature changes, the monitoring and control circuits sense the change of the electric signal (e.g. I-V) of the temperature sensors, and obtain the (local) temperature readings. In some embodiments, the temperature sensors are implemented by the optical signals of different materials, such as Si, SiN, Complex Oxide (e.g. Lithium Niobate, Barium Titanate), or III-V. In an optical resonator implementation, the resonant wavelength is a function of the temperature due to the thermo-optical effect of the materials. In these embodiments, the heater element is formed from materials having resistance, such as doped Si, metals (e.g. Al, Cu, W, TiN, etc.), doped dielectrics.

In some embodiments, each arm in the quantum GMZI switch architecture 800 is controlled by a set of phase shifters: a slow phase shifter 820 and a fast phase shifter 815. At a high level, the slow phase shifter 820 is configured to minimize or zero out a phase difference between input and output light. For example, input light is light inputted into the left side of the first Hadamard network (e.g., the first Hadamard gate) 805 and the output light is light outputted from the right side of the second Hadamard network 825 (e.g., the second Hadamard waveguide coupler network) and measured to perform adjustments. In some embodiments, the slow phase shifters 820 are implemented to configure the quantum GMZI switch architecture 800 for a given optical processing configuration (e.g., zero out fabrication-based loss sources, adjust global phases, or compensate for temperature variations across the optical device). For example, the slow phase shifter 820 is configured to manage local temperature issues, such as the differences between the temperature of different areas of the quantum GMZI switch architecture 800 to ensure the phase differences are zeroed out. Further, in accordance with some embodiments, the slow phase shifters 820 are implemented to zero out phase difference between different GMZIs (e.g., other instances of the quantum GMZI switch architecture 800 that are connected to the GMZI shown in FIG. 8), such that multiple GMZIs are interconnected and zeroed out across all devices to ensure the fast phase shifters operate with sufficient 0 to π phase shifts in operation.

In some embodiments, one or more of the fast phase shifters 815 are implemented during operation of the quantum GMZI switch architecture 800 to provide precise 0 to π phase shift swings to implement quantum entanglement operations (e.g., apply a desired Hadamard transformation matrix) and to provide routing operations (e.g., routing of bright light, routing of single photons, routing of entangled state photon probability distributions). Although, in FIG. 8, the waveguides are illustrated is straight, it is appreciated that the waveguides may fan-in and fan-out as discussed above (FIG. 7) to minimize loss of optical modes that cause fatal errors in the quantum optical state generation.

FIG. 9A shows an architecture 999 for constructing a quantum optical coupler network (e.g., the first Hadamard network 805, waveguide coupler network), in accordance with some embodiments.

Each of optical coupler network can be designed as blocks (rectangles in FIGS. 9A and 9B) of sub-block networks. The blocks can be implemented using different optical components, such as MMIs (e.g., crossing couplers) and directional couplers (e.g., non-even couplers, such as 100:0 power slitter directional couplers, or even couplers such as a 50/50 directional coupler).

Legend 959 shows example sets components that can be implemented as the dark blocks (darker shade rectangles in FIGS. 9A and 9B) of the crossing network and lighter blocks (lighter-shade cross-hatched rectangles in FIGS. 9A and 9B). As shown in the legend 959, in a first combination of components blocks 960, the lighter blocks are implemented as crossing couplers 963 (e.g., star crossing MMIs) and the darker blocks are 50/50 directional couplers 964.

Further, in some embodiments, the quantum optical coupler networks (e.g., Hadamard networks) are formed using the second combination of component blocks 962, in which the darker blocks are non-even directional couplers 965 (e.g., a directional coupler in a 100:0 or 0:100 configuration), and the lighter blocks are 50/50 directional couplers 966. In some example embodiments implementing the second combination of component blocks 962, the non-even directional couplers are configured such that one of the two outputs (e.g., the two output waveguides on the right side of block 965) that is in the direction of the slant (fan-in, taper in) receives most or 100% of the light input into the coupler. For example, with reference to block 997B, the light can propagate from left to right and the crossing network (dark blocks) are then a fan-in crossing network in which the directional coupler output port that is nearer to the center axis of the subblock 997B is configured to output the light from power splitter, thereby each of the non-even power splitters direct their light in an angled or tapered in manner along the hierarchy of the fan-in network.

In the example shown in FIG. 9A, the coupler network 505 is decomposed into sub-blocks 998A, 998B, and 998C. For example, sub-block 998A may be constructed from unit cells in the arrangement 997A. Similarly, sub-block 998B may be constructed from unit cells in the arrangement 997B. Similarly, larger sub-blocks may be constructed in a similar manner; for example, sub-block 998C may be constructed using the construction shown in general arrangement 997C.

FIG. 9B shows a quantum optical network architecture 900 in accordance with some embodiments. In the example of FIG. 9B, the quantum optical network architecture 900 is a scalable architecture that can be used to create a scalable family of Hadamard coupler networks (e.g., the first Hadamard network 805, the second Hadamard network 825), such as two 4×4 blocks that couple into an 8×8 block, or two 8×8 blocks that couple to or from a 16×16 block as illustrated in FIG. 9B. The quantum optical network architecture 900 is scalable and can be replicated in design for arbitrary sizes (e.g., N=4, 8, 16, 32, 64, 128, and so on). Further, the quantum optical network architecture 900 may be implemented as Hadamard networks as discussed above (e.g., entangled state generators or GMZIs that function as routers). In the example of FIG. 9B, the quantum optical network architecture 900 is balanced by default, and useful for any hardware platform where only local waveguide variability is guaranteed to be small. Further, although specific splitting and cross components are discussed here as examples, different pairings of 2×2 splitting and cross components may be implemented in the quantum optical network architecture 900 (e.g., after adjustment to the same height), in accordance with some embodiments.

A high level, if an input light is input into a port (e.g., single waveguide) of the first interface 903 (e.g., input interface) then the power of the light is distributed to one or more of the output ports of a second interface 907 (e.g., a plurality of output ports, plurality of waveguide outputs, a N-to-1 transfer matrix). Or vice versa. Alternatively, if multiple lights are input into multiple ports of the first interface 903, then interference occurs between the multiple lights in the quantum optical network architecture 900 and the light is coupled to the second interface 907 in accordance with the transfer matrix or desired permutation, as discussed above.

In some embodiments, the quantum optical network architecture 900 functions as a Hadamard network. In some embodiments, the Hadamard network is implemented with passive optical components, such as optical fibers, straight waveguides, waveguide bends, waveguide crossings, directional couplers, N×N couplers (N>2), and so on. The optical waveguides may be manufactured by different platforms and material, such as silicon, silicon nitride, doped SiO2, complex oxide (e.g., lithium niobate, barium Titanate), or III-V materials.

In the quantum optical network architecture 900, each unit block corresponds to an optical subcomponent, such as a star coupler 975 or a directional coupler 976 (e.g., 50/50 directional coupler, 100:0 directional coupler, 0:100 directional coupler). In some embodiments, each unit block comprises a height, h. In the illustrated example of FIG. 9B, a sub-network 910 (e.g., 4×4 network, a smaller beam splitter network comprising one or more of: a directional coupler, a star or a crossing coupler, a delay) is spaced 2 h away from a second sub-network 910 (e.g., smaller beam splitter network). With reference to the sub-network 910, a plurality of star crossing blocks (e.g., a crossing coupler or a star coupler) such as a star crossing block 915 (shown as lightly shaded blocks in FIG. 9A) are interconnected to create a crossing network that couples to a plurality of 50/50 directional couplers 920 (shown as darker shaded blocks in FIG. 9A). In some embodiments, a star crossing coupler is an optical device that takes in an input signal and splits it into several output signals (e.g., two waveguides that cross one another to create a common cavity from which four ports extend). For example, light input into 1 of the 4 ports of a star crossing coupler is output from the other 3 ports; light input into 2 of the ports is output from the other 2 ports, and so on. Star crossing couplers can have a common cavity, similar to a MMI common cavity, that has a reduced footprint (e.g., similar to larger MMIs with large common cavities).

In some embodiments, the second sub-network 910 is similarly configured: a star crossing network that couple to a plurality of directional couplers. Each of the first sub-network 905 and the second sub-network 910 are coupled via a waveguide transition 925, a balanced log tree that performs match routing as discussed above with reference to FIG. 7. The waveguide transition 925 is coupled to a third sub-network 930 that is larger than the first sub-network 905 and the second sub-network 910. As an example, the third sub-network 930 comprises a plurality of star crossing blocks that are coupled to a plurality of directional couplers (e.g., 50/50 power splitters). As shown in further detail below, a star crossing block may have one or more unused input or output ports which are terminated using waveguide absorbers in accordance with some embodiments. In some embodiments, the unused ports of the star crossing units are implemented is drop ports.

In the example of FIG. 9B, the diagonal lines crisscrossing the cross network of star crossings illustrate the optical paths, where for example a star crossing block 935 has two unused ports, in contrast to star crossing block 937 that has all ports coupled to other units.

FIG. 9C shows example components implemented as unit cells in the coupler network in accordance with some embodiments. As illustrated, the crossing coupler 975 (e.g., a low loss MMI coupler) comprises two waveguides that cross one another to create a 2×2 coupler arrangement. Further, a directional coupler 976 comprises two waveguides that come near one another to evanescently coupler light to form a type of 2×2 coupler, in accordance with some embodiments.

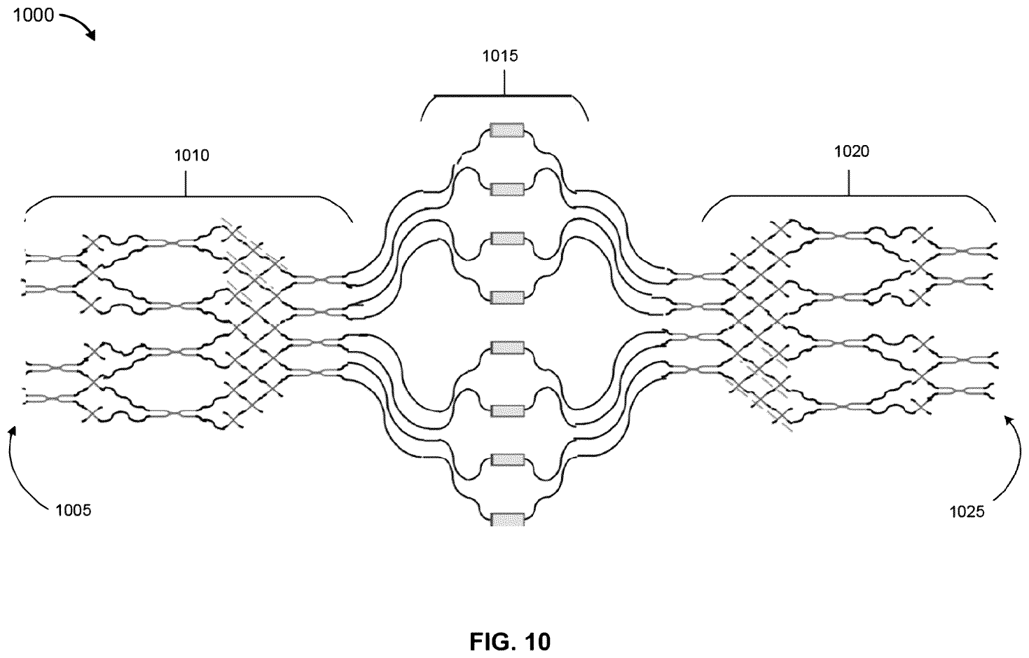

FIG. 10 shows a quantum GMZI architecture 1000 in a balanced configuration in which the optical powers across the network are equivalent in accordance with some embodiments. In the example quantum GMZI architecture 1000 comprises two instances of an 8×8 Hadamard network: a first Hadamard network 1010 and a second Hadamard network 1020, which are each implemented using the configuration illustrated in FIG. 9B.

In some embodiments, such as in FIG. 10, the GMZI is designed so that the optical paths are balanced by default (e.g., the first Hadamard network 1010 is a mirror image of the second Hadamard network 1020) which may improve scalability of the GMZI by creating large self-similar waveguide network (e.g., Fractal networks) that are balanced and remain in phase. In some embodiments, light is input into a plurality of couplers 1005 (e.g., grating couplers or the first interface 903) and is coupled to a plurality of couplers 1025 (e.g., the second interface 907 or a plurality of grating couplers). On a high level, the quantum GMZI architecture 1000 comprises the first Hadamard network 1010 and the second Hadamard network 1020 connected by phase shifters 1015 (e.g., fast phase shifters, slow phase shifters, or the top arm waveguides (e.g., fixed passive phase shifters) 685 in FIG. 6B).

FIG. 11A shows the first Hadamard network 1010 in accordance with some embodiments. In the illustrated example of FIG. 11A, the light is inputted into a plurality of directional couplers 1105 configured as 50:50 power splitters. A plurality of directional couplers 1105 are coupled into a crossing network 1110 comprising a plurality of interconnected star couplers (e.g., a waveguide star crossing network). As illustrated, one or more of the star networks in the crossing network 1110 have pairs of unused ports that are terminated with waveguide absorbers (not depicted), in accordance with some embodiments. The crossing network 1110 is physically expanded via an array of Euler bends 1113 that are coupled into splitters 1115 (e.g., a plurality of directional couplers) configured as 50:50 power splitters, which are then coupled into a larger crossing network 1120 of star couplers, wherein one or more of the star couplers along the edge have unterminated ports and the star couplers in the middle of the crossing network 1120 have all ports that are all connected to other or subcomponents (e.g., directional couplers). Further, the directional couplers 1125 that are configured as 50:50 power splitters, which coupler light to the phase shifters 1015 (FIG. 10).

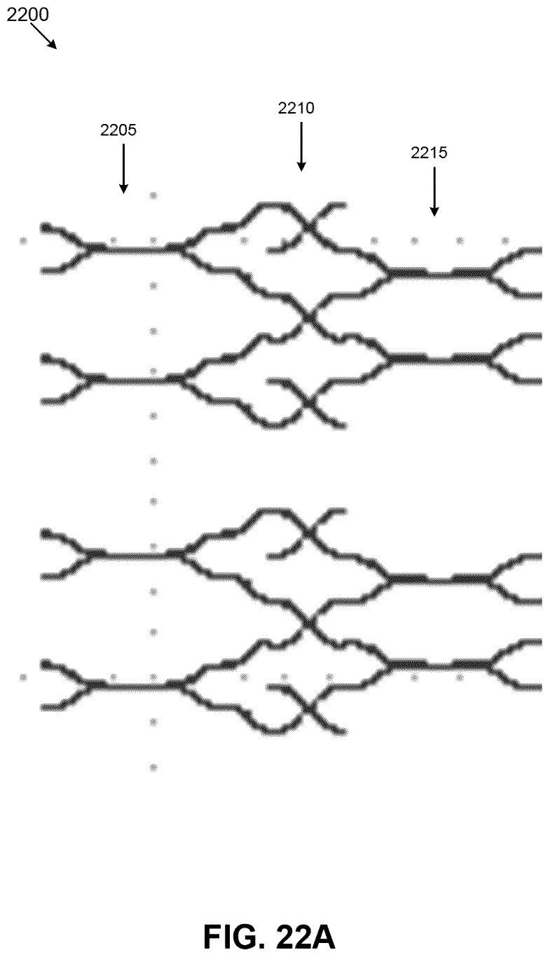

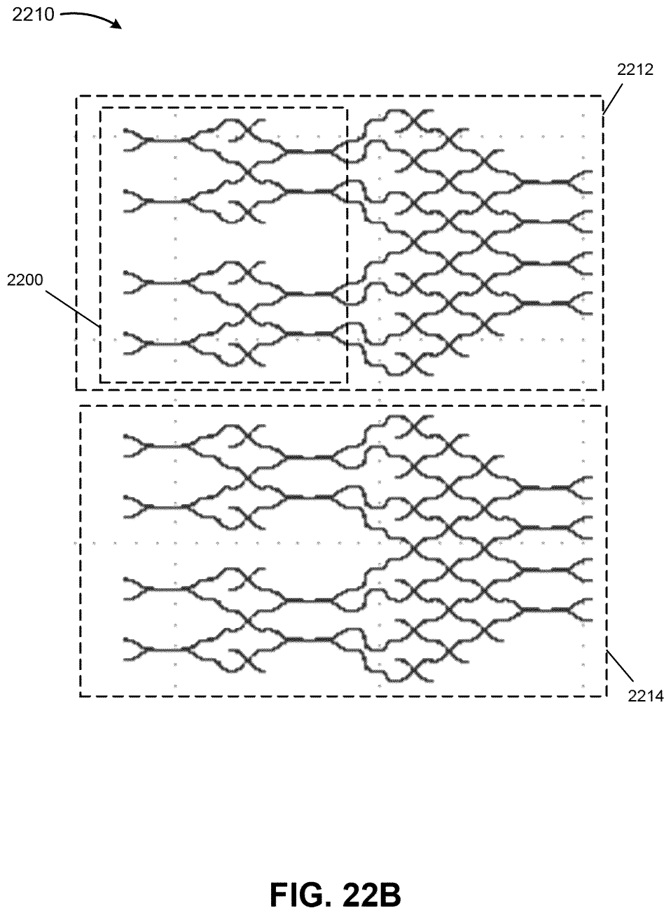

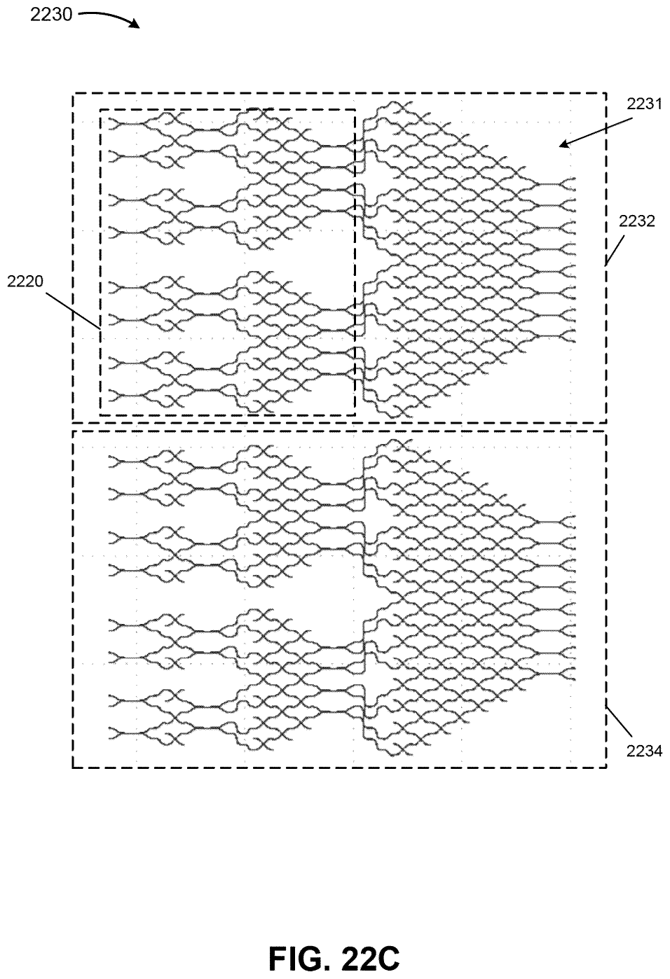

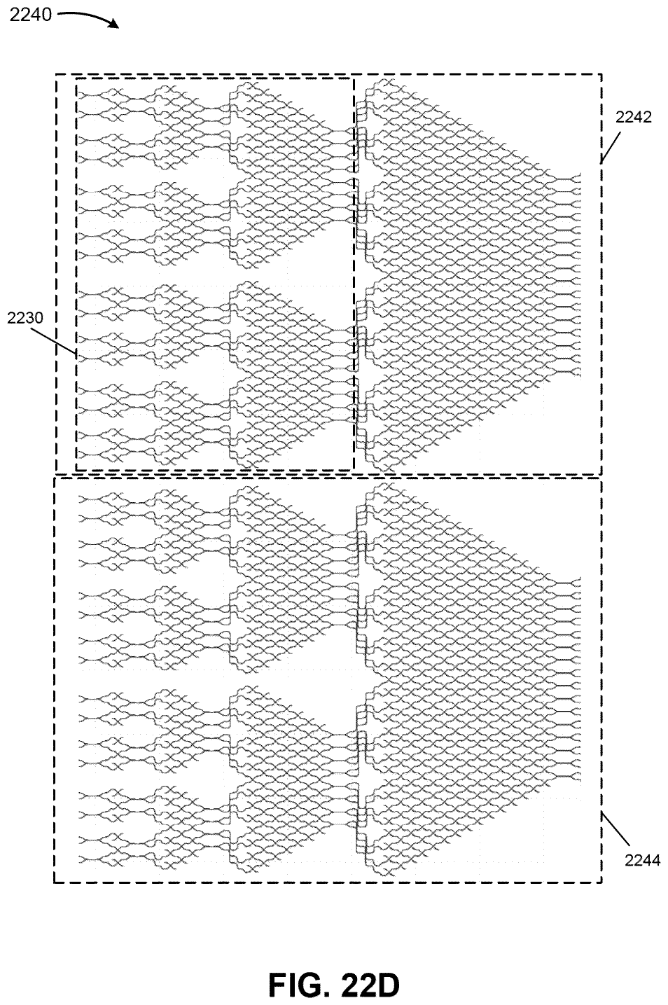

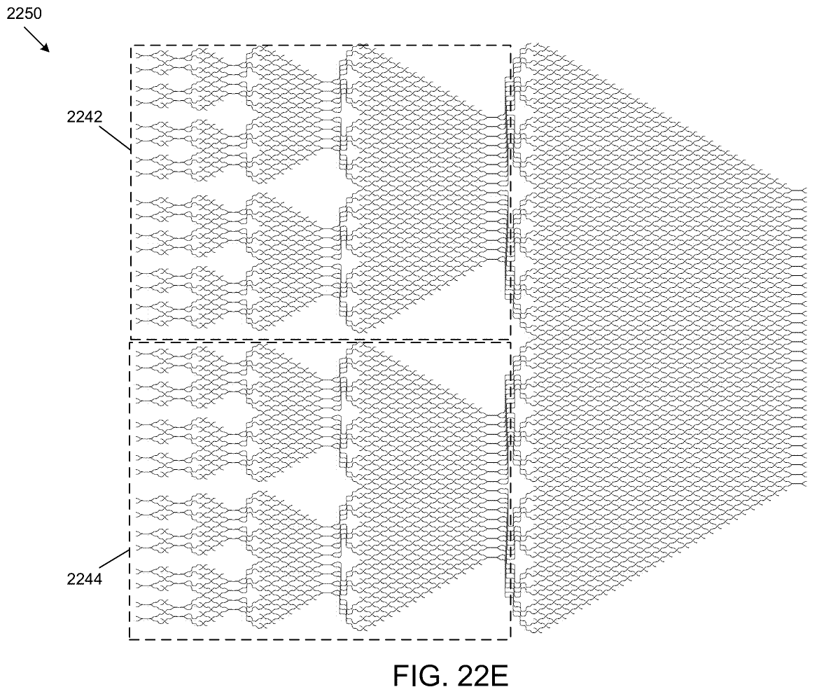

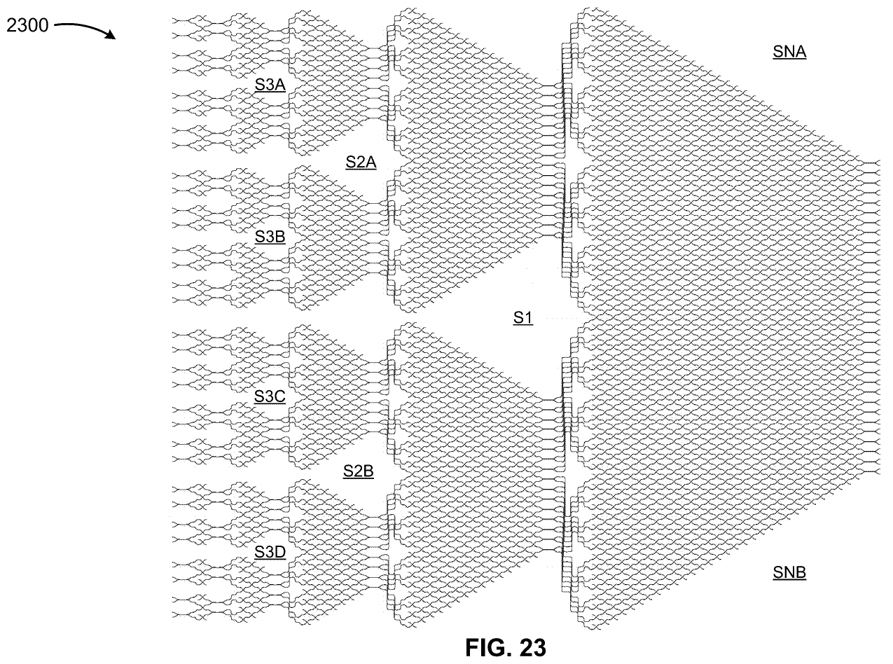

FIG. 11B shows an example scalable sub-network unit 1150 that is scalable to larger and larger sizes, as discussed in further detail with reference to FIGS. 22A-23. In the example of FIG. 11B, the scalable sub-network unit 1150 comprises an array of input ports 1114 that input into an array of splitters 1115 (e.g., directional couplers) that physically expand using an array of Euler bends 1117 that feed into a crossing network 1120 (e.g., an array of crossing couplers) that output light to an array of output ports 1123. Although the example of FIG. 11B shows a specific ordering of couplers to bends to a crossing network, it is appreciated that a scalable network unit may be ordered otherwise. For example, with reference to FIG. 11A, a scalable unit may comprise the Euler bends 1117, followed by the crossing network 1120, which terminate into the directional couplers 1125 that have output waveguides to output the light, in accordance with some embodiments.

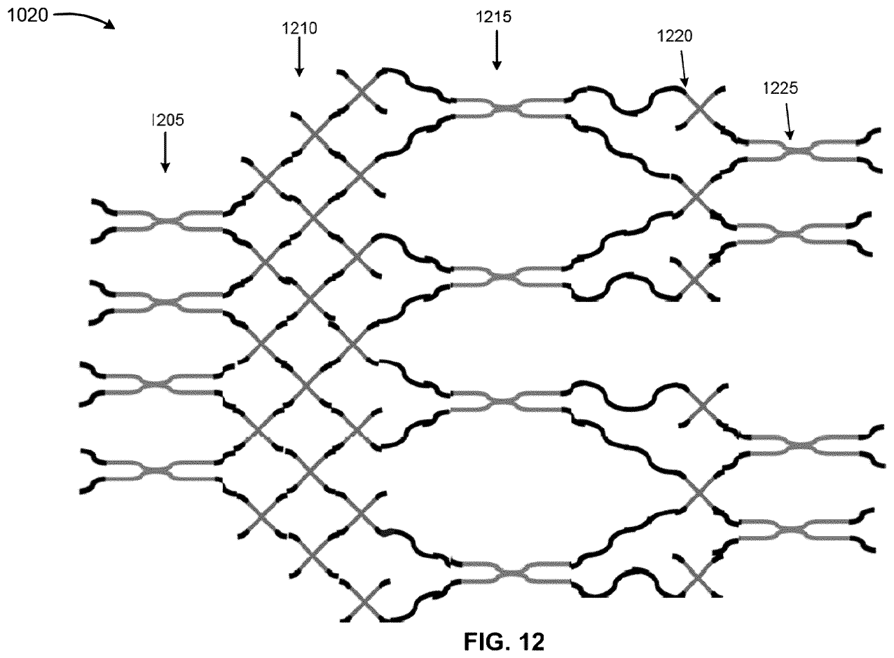

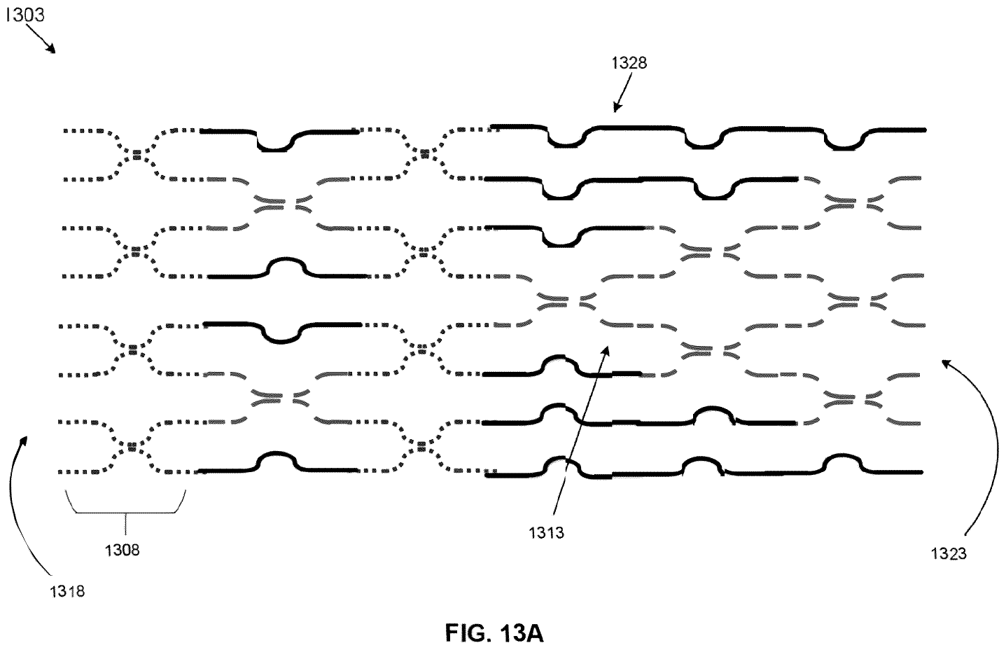

FIG. 12 shows the second Hadamard network 1020 in accordance with some embodiments, in the illustrated example of FIG. 12, the light from the phase shifters is inputted into a plurality of directional couplers 1205 (e.g., directional couplers in a 50:50 power splitting configuration). The plurality of directional couplers 1205 are coupled to a crossing network 1210 of waveguide routings that are configured as star couplers. The crossing network 1210 is coupled to a plurality of directional couplers 1215 configured as 50:50 power splitters, which couple light into an additional crossing network 1220 comprising star couplers formed from waveguides. The additional crossing network 1220 couples light into a plurality of directional couplers 1225 which couple the light to an output interface (e.g., one or more other optical devices or output ports) in accordance with some embodiments.

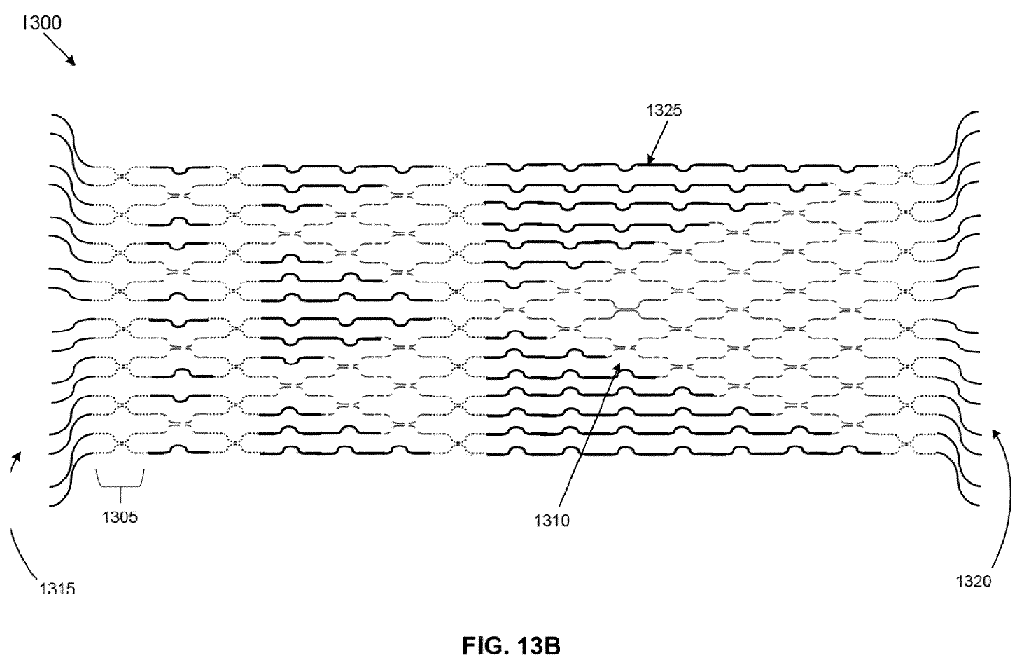

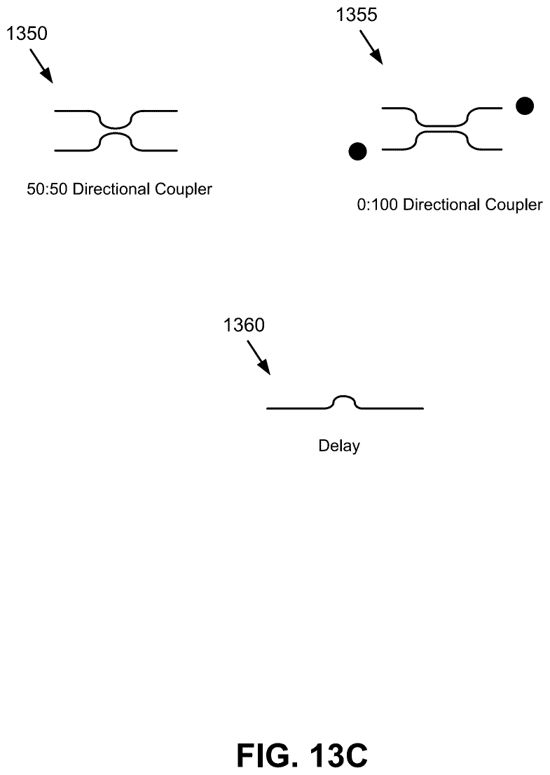

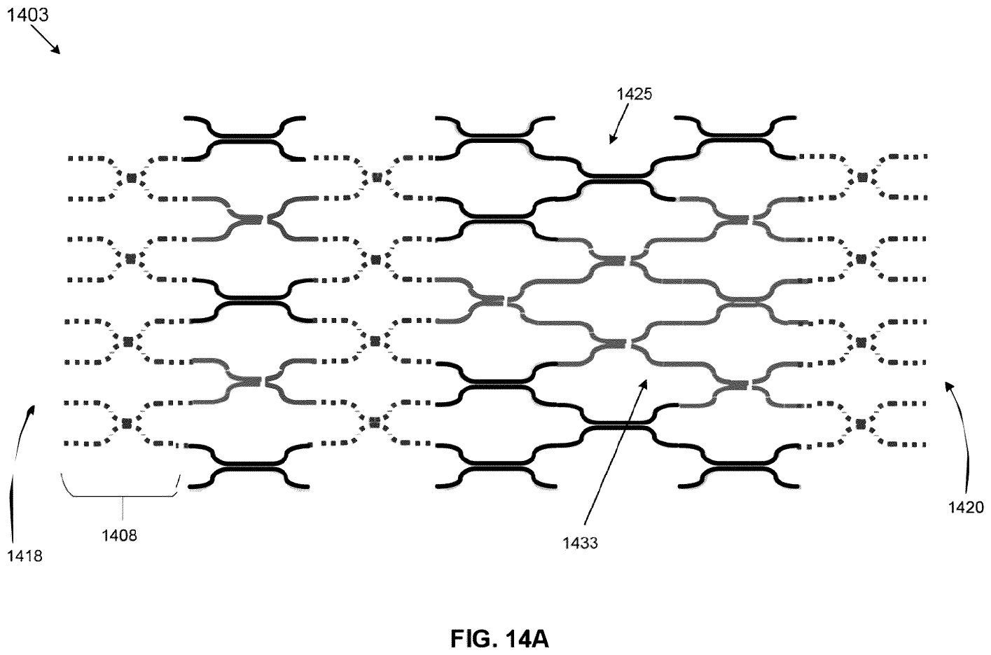

FIG. 13A shows a passive compact Hadamard network architecture 1303 that is scalable to larger sizes as shown in FIG. 13B below. With reference to FIG. 13A, the subcomponents include a plurality of input ports 1318 that input into an array of 50:50 directional couplers 1308 (e.g., shown in dotted lines) and further include 0:100 directional couplers, such as a directional couplers network 1313 (e.g., shown in dashed lines) and delay structures such as humps 1328 to ensure that the light on the different arms couple across the coupler network but is in phase at the output ports 1323.

FIG. 13B shows a passive compact Hadamard network architecture 1300 in accordance with some embodiments. An advantage of the passive compact Hadamard network architecture 1300 is that it may be designed as a highly compact circuit, which in some circumstances reduces propagation distances compared to the embodiment of FIG. 9B (e.g., the overall height is half compared to the embodiment of FIG. 9B), which thereby minimizes optical losses and the effects of waveguide variation. Another potential advantage of the embodiment in FIG. 13B is that it eliminates internal routing with curvy links used for the approach of FIG. 9B. These advantages enable non-trivial solutions to useful phase matching phase-matching conditions for various different optical circuits.

The passive compact Hadamard network architecture 1300 may be implemented as one of the Hadamard network blocks such as the first Hadamard network 610 or the second Hadamard network 620 (FIG. 6), or the first Hadamard network (e.g., the first Hadamard network) 805 or the second Hadamard network 825 (FIG. 8). The passive compact Hadamard network architecture 1300 of FIG. 13B is an example unbalanced crossing network formed from passive components that enable the passive compact Hadamard network architecture 1300 to be highly compact and very low loss.

The example subcomponents are shown in FIG. 13B, and include a 50/50 directional coupler 1305 (e.g., shown in dotted lines), a 0:100 directional coupler 1310 (e.g., shown in dashed lines) that receives light from one input port and directs it to a diagonal output port, and a waveguide segment with a phase compensation structure (e.g., hump or delay path). A waveguide segment may be implemented to perform phase and phase-length matching to make the pads for crossing and non-crossing segments equivalent in the passive compact Hadamard network architecture 1300 in accordance with some embodiments. In the passive compact Hadamard network architecture 1300, the 50/50 directional couplers are illustrated as dashed lines, such as the column of directional couplers 1305. Further, the 0:100 directional couplers are illustrated as dotted lines such as in the triangular region of 0:100 directional couplers, and solid lines correspond to the waveguide segments of ports, such as input ports 1315 or output ports 1320, and the waveguide segments with delays are also shown in solid lines, such as in the waveguide segment region 1325.

FIG. 13C show a close-up view of the 50:50 directional couplers 1350, the 0:100 directional coupler 1355, and a delay 1360 (e.g., hump) in accordance with some embodiments.

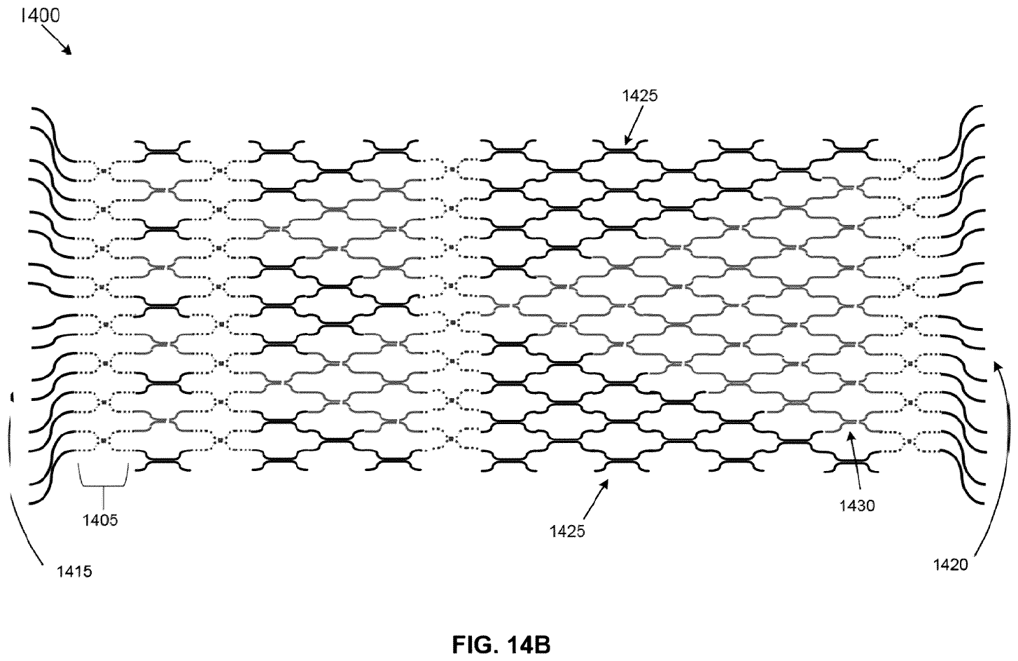

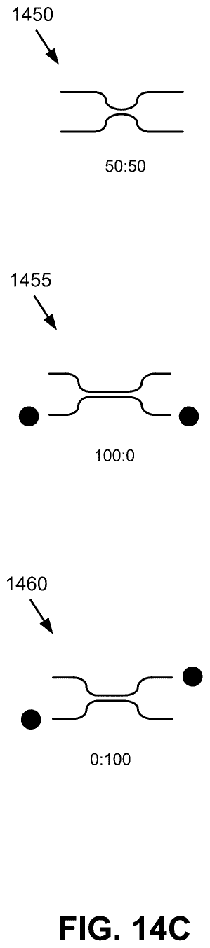

FIG. 14A shows a passive compact Hadamard network architecture 1403 that is scalable to larger sizes as shown in FIG. 14B below. With reference to FIG. 14A, the subcomponents include a plurality of input ports 1418 that input into an array of 50:50 directional couplers 1408 (e.g., shown in dotted lines) and further included 0:100 directional couplers, such as a directional couplers network 1433 (e.g., shown in dashed lines) and delay structures such 100:0 directional couplers to ensure that the light on the different arms couples across the coupler network but is in phase at the output ports 1420.

FIG. 14B shows a passive compact Hadamard network architecture 1400, in accordance with some embodiments. The passive compact Hadamard network architecture 1400 may be implemented as one of the networks discussed above, such as the first Hadamard network 610 or the second Hadamard network 620 (FIG. 6), or the first Hadamard network 805 or the second Hadamard network 825 (FIG. 8). The passive compact Hadamard network architecture 1400 of FIG. 14 includes input ports 1415 and output ports 1420, and is an example unbalanced crossing network formed from passive components that enable the passive compact Hadamard network architecture 1400 to be highly compact and very low loss. The example subcomponents implemented in the passive compact Hadamard network architecture 1400 are shown in FIG. 14C. The subcomponents include a 50/50 directional coupler 1450, a 100:0 directional coupler 1455 (e.g., in a bar state) that couples the light straight across the couplers, and a 0:100 directional coupler 1460 (e.g., in a cross state) that receives light from one input port and directs it to a diagonal output port. In the passive compact Hadamard network architecture 1400, the 50/50 directional couplers are illustrated as dashed lines, such as the column of directional couplers 1405. Further, in the passive compact Hadamard network architecture 1400 of FIG. 14B, the 100:0 directional couplers are illustrated as dash-dot lines, such as in the region 1425 and the region 1430. Further, in the passive compact Hadamard network architecture 1400 of FIG. 14A, and the 0:100 directional couplers are illustrated as dotted lines, such as in the region directional couplers 1408.

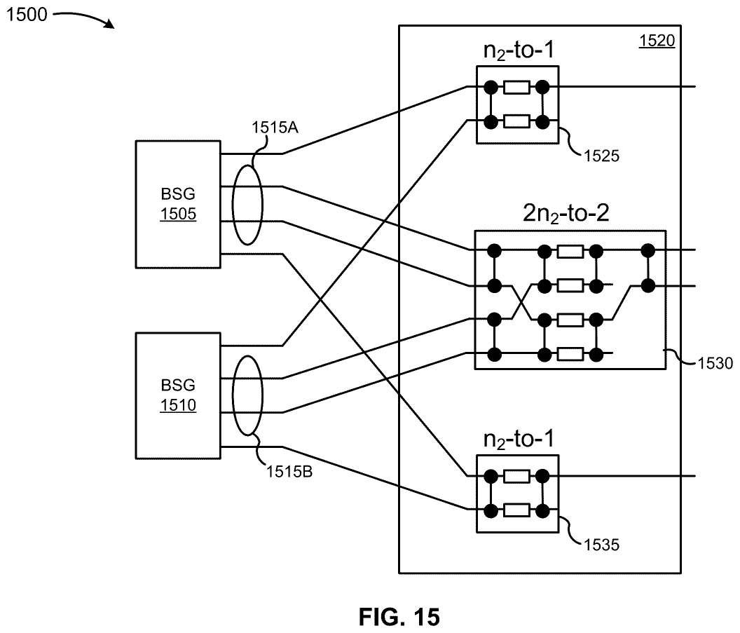

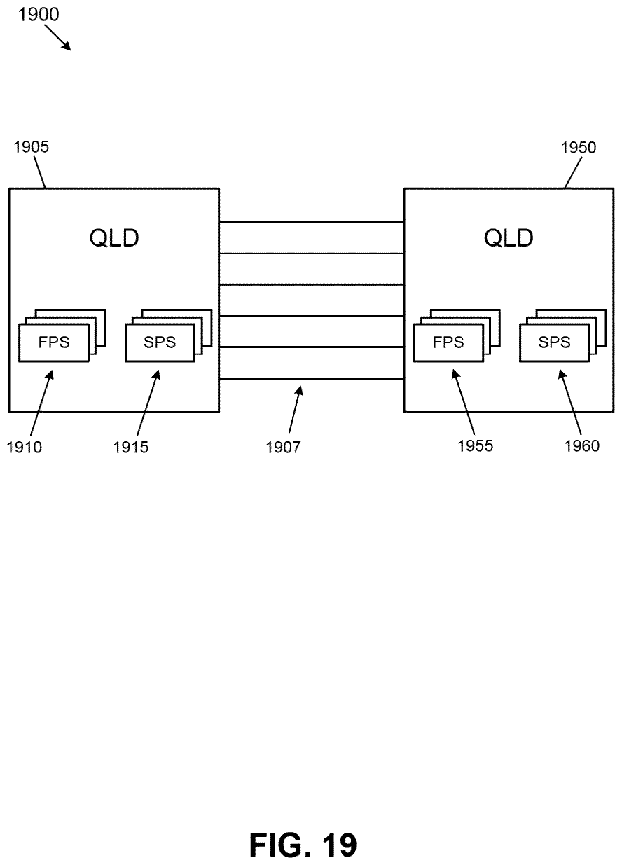

FIG. 15 shows a quantum optical photonic device architecture 1500 that implements one or more quantum GMZIs, in accordance with some embodiments. As discussed above, the GMZI matrix Dk may be determined up to a setting-dependent global phase factor e^{iϕ}^{ₖ}. In some embodiments, the global phase factors is freely set over range from 0 to 2 using a plurality of phase shifters (e.g., slow phase shifters, heaters, BTO phase shifters configured for 0 to 2π swing). In some embodiments, in a quantum application of single-photon muxing, the global phase factors do not affect the operation of the switch network (e.g.., they are used to set the global phase of the system and do not affect probability densities and modes). However, the global phase may be useful to set if the switch network is applied to only part of the input states (e.g., such as single rails from dual rail photon qubits) or if incorporated in network photonic devices, such as the networks illustrated in FIG. 19. As such, the global phase factor may be implemented to perform multiplexing for a quantum light circuit (e.g., fault tolerant quantum logic processing and computing) that generates entangled quantum photonic states (e.g., clustered groups of entangled photons) while also applying internal adaptive corrections to the quantum photonic output.

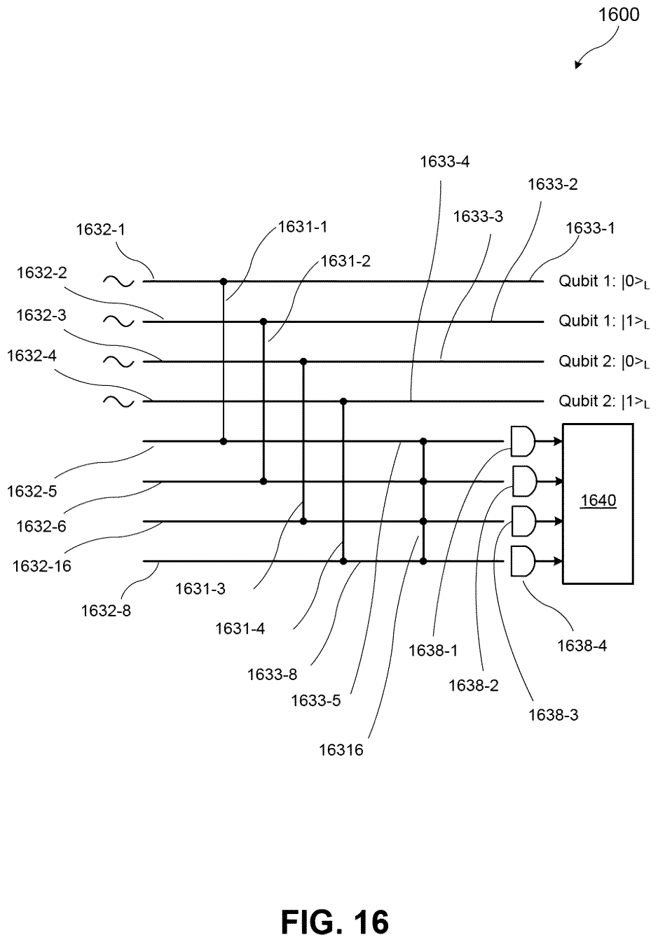

With reference to the quantum optical photonic device architecture 1500, the quantum light photonic device implementing the quantum optical photonic device architecture 1500 comprises a first Bell state generator photonic circuit 1505 and a second Bell state generator photonic circuit 1510, which may each generate a photonic Bell state across 4 modes (e.g., waveguides) with a probability of 3/16. Further details of the Bell state generators are discussed with reference to FIG. 16 below.

While the BSGs may generate photons in Bell states, these states do not conform to the dual rail photonic cubing encoding in which qubits are allocated to fixed pairs of waveguide modes in a third of the cases. In some embodiments, a quantum GMZI 1520 (e.g., the quantum GMZI switch architecture 800, FIG. 8) is implemented to mux and swap the inner rails 1515A and 1515B from the respective BSG generators. For example, and in accordance with some embodiments, the quantum GMZI is configured with multiple submodules, including switch submodules: a first quantum GMZI submodule 1525 (e.g., a first n₂-to-1 mux) and a second quantum GMZI submodule 1535 (e.g., a second n₂-to-1 mux) that manage the outer rails, and a third quantum GMZI submodule 1530 (e.g., 2ₙ2-to-2) that swap and mux the inner rails to increase the success probability of generating a dual rail encoded Bell state from 1/8 to 3/16. Further, by implementing the quantum GMZI in this way, the amount of multiplexing is overall reduced compared to previous designs (e.g., reduce by a factor of 1.5 or more).

Although in the example of FIG. 15 discussed above, the three submodules are integrated in a single quantum GMZI, it is appreciated that that subcomponent muxes may be implemented in different GMZIs (e.g., different chips, different devices), as discussed in further detail with reference to FIG. 19. As an example, a first GMZI (e.g., the quantum GMZI switch architecture 800, a first quantum light processing device 1905 in FIG. 19 below) can implement the first quantum GMZI submodule 1525 and the third quantum GMZI submodule 1530. Further, a second GMZI (e.g., a second instance or chip comprising the quantum GMZI switch architecture 800, a second quantum light processing device 1950 in FIG. 19 below) may implement the second quantum GMZI submodule 1535, thereby enabling scalable and flexible quantum light circuitry to be designed.

Analytically, the phase shifter and beam splitter operations of the GMZI's implemented in the BSG may be generated matrix decomposition from unitary matrixes. For example, the unitary matrices V (nt) may be decomposed into elementary beam-splitter and phase-shifter operations using decomposition. Alternatively, since the V (nt) are assumed to be discrete Fourier transforms, they may be recursively decomposed into smaller discrete Fourier transforms acting on sets of local modes

$${I}^{\frac{{n}_{l}}{{n}_{l}^{′}}} ⊗ {V}^{( {n}_{l}^{′} )} , {I}^{\frac{{n}_{l}}{{n}_{l}^{′′}}} ⊗ {V}^{( {n}_{l}^{′′} )}$$

(for any sizes satisfying n_l=n_l\hat{ }′×n_l\hat{ }″) together with crossings networks and additional phase shifts.

As discussed, one feature of a GMZI is that the matrices Dₖ for the GMZIs are determined up to a setting-dependent global phase factor e^{iϕ}^{ₖ}. In some embodiments, the global phase are freely set over a range (e.g., zero to 2π), provided the active phase shifters in the GMZI are also configured with sufficient phase range. For an application such as single-photon multiplexing, the global phase factors have no role in the operation of the switch network. However, they may be useful if the switch network is applied to only some part of the input states (e.g. single rails from dual-rail qubits) or if it is incorporated in larger interferometers. In these cases, additional functionality may be absorbed into the operation of the switch network without adding extra layers of switching.

As discussed above, this may be useful where the GMZI is to perform different functions, such as multiplexing one or more circuits to generate entangled states (e.g., the quantum GMZI submodules 1525, 1530) while also performing additional routing and quantum light operations (e.g., applying internal adaptive error corrections to an output).

More generally, the transfer matrices associated with a GMZI that implements a given set of routing operations (e.g., [symbol] ([n₁, n₂])) are

$$\begin{matrix}{P}_{( {k}_{1} , {k}_{2} )} = {( {C}^{( {n}_{1} )} )}^{{k}_{1}} ⊗ {( {C}^{( {n}_{2} )} )}^{{k}_{2}} \\ = {( {C}^{( {n}_{1} )} ⊗ {I}^{( {n}_{2} )} )}^{{k}_{1}} {( {I}^{( {n}_{1} )} ⊗ {C}^{( {n}_{2} )} )}^{{k}_{2}} .\end{matrix}$$

In regard to the quantum optical photonic device architecture 1500 of FIG. 15, this may be interpreted as n₁ separate copies of n₂-to-1 GMZIs (second term) with an additional set of permutations of the n₁ outputs also available (first term). In this way, permutations of n₁ rails may be implemented while multiplexing each one n₂ times by sending all N=n₁n₂ inputs through a single larger GMZI (e.g., the quantum GMZI switch architecture 800 or the quantum GMZI architecture 1000) rather than smaller separate ones. The key advantage of this method is that the depth and total number of active phase shifters do not change (1 and N respectively).

Using a larger GMZI comes at the cost of increasing the optical depth of the circuit, particularly in terms of waveguide crossings. As seen from the expression of W above, the passive interferometers in a GMZI may be decomposed into smaller networks connected by layers of crossings. This modular structure may be exploited to distribute parts of the circuit across different locations and avoid large on-chip crossing networks, as shown in FIG. 19 and discussed below.

As discussed above, GMZIs have assorted configurations that may be integrated as operational blocks in spatial or temporal mux architectures and devices. Furthermore, alternative constructions of GMZIs are also possible using the design and operating configurations as follows. One observation is that phase swing requirements (e.g., where the swing is defined per phase shifter as the difference between the maximum and minimum phase shifts across all GMZI settings) may sometimes be reduced by introducing fixed phase-shift offsets (e.g., fixed waveguide delays). For some of the constructions above, the phase shifter settings correspond to complete sets of roots of unity, and the phase swing is π for Hadamard interferometers and >π for the other GMZI types. Table 1 shows examples of reduced swing for GMZI sizes N=2,3,4 including examples of GMZIs with reduced phase swing using fixed phase-shift offsets. In some embodiments, all the fast phase shifter components are identical and access the same range of phase shifts (e.g., which has been minimized or zeroed out). As such, in some embodiments, the use of offsets necessitates modification of the GMZI transfer matrices by additional phase factors—corresponding to setting-dependent “global” phases at the output.

TABLE 1

| | Phase | |
|---|---|---|
| GMZI type | offsets | Comment |
| Hadamard N = 2 | $( - \frac{3 π}{2 , 0} )$ | $Swing reduced from π to \frac{π}{2} , coinciding with MZI variant in$ |
| | | FIG. 3A. |
| DFT N = 3 | $( - \frac{4 π}{3 , 0 , 0} )$ | $Swing reduced from \frac{4 π}{3} to \frac{2 π}{3} .$ |
| Hadamard | (−π, 0,0,0) | Swing unchanged at π, but for each setting only one phase |
| N = 4 | | shifter is set to π and the others to 0. |

As discussed, the transfer matrices Uₖ=WDₖV^{†} on N modes of a given GMZI architecture may function as N-to-1 muxes. In some embodiments, V in this case must be proportional to a complex Hadamard matrix (e.g., V must satisfy

$$\vert {V}_{s , t} \vert = \frac{1}{\sqrt{N}}$$

as well as being unitary), and furthermore, the phase vectors dₖ must be orthogonal. As such, a consequence of this is that it is impractical implement a GMZI for which the phase-shifter swing is less than

$$\frac{π}{2}$$

(e.g., since it is never possible to achieve 0 for the real part of [symbol] dₖ, dₖ′ [symbol] ). Similarly, when the phase-shifter values are restricted to

$$\{ 0 , \frac{π}{2} \}$$

it is not possible to find more than 2 orthogonal vectors dₖ for any even value of N (and never more than 1 for odd values of N), which is to say that it is not possible to do better than a 2-to-1 mux.

In some embodiments, for sets of orthonormal phase vectors {dₖ} a GMZI (e.g., the quantum GMZI switch architecture 800) is configured to use the phase vectors as phase settings for a N-to-1 mux, by choosing V to have row vectors vₖ=dₖ, and any unitary W with first row vector

$${w}_{1} = \frac{1 , 1 , … , 1}{\sqrt{N}} .$$

In accordance with some embodiments, an example set of phase vectors is shown in Table 2 below. More specifically, Table 2 shows examples of six orthogonal phase vectors with a subset d₁, . . . , d₄ having a reduced phase swing of

$$\frac{2 π}{3}$$

(e.g., compared to

$$\frac{4 π}{3}$$

for the entire set). As an example, a GMZI having N=6 can use the Table 2 settings to implement a 4-to-1 mux which has phase swing of only

$$\frac{2 π}{3}$$

(e.g., by restricting to the first four phase-shifter settings).

TABLE 2
Settings for a N = 6 GMZI acting as a 6-to-1 mux
${d}_{1} = \frac{1 , 1 , 1 , {e}^{- \frac{21 π}{3}} , {e}^{- \frac{21 π}{3}} , {e}^{- \frac{21 π}{3}}}{\sqrt{6}}$
${d}_{2} = \frac{1 , {e}^{- \frac{21 π}{3}} , {e}^{- \frac{21 π}{3}} , 1 , {e}^{- \frac{21 π}{3}} , 1}{\sqrt{6}}$
${d}_{3} = \frac{{e}^{- \frac{21 π}{3}} , 1 , {e}^{- \frac{21 π}{3}} , {e}^{- \frac{21 π}{3}} , 1 , 1}{\sqrt{6}}$
${d}_{4} = \frac{{e}^{- \frac{21 π}{3}} , {e}^{- \frac{21 π}{3}} , 1 , 1 , 1 , {e}^{- \frac{21 π}{3}}}{\sqrt{6}}$
${d}_{5} = \frac{1 , {e}^{- \frac{21 π}{3}} , {e}^{- \frac{41 π}{3}} , {e}^{- \frac{21 π}{3}} , 1 , {e}^{- \frac{41 π}{3}}}{\sqrt{6}}$
${d}_{6} = \frac{{e}^{- \frac{21 π}{3}} , 1 , {e}^{- \frac{41 π}{3}} , 1 , {e}^{- \frac{21 π}{3}} , {e}^{- \frac{41 π}{3}}}{\sqrt{6}}$

Further, the phase settings of the GMZIs may be modified such that a single input port may be connected to a single output port. In particular, for example, taking Hadamard-type GMZIs with transfer matrices Uₖ=WDₖW^{†} on N modes, consider first when the phase vector dₖ′ for D_{k′} is modified so that −π phases are set to a (common) value −ϕ, while the 0 phases are unchanged. In this case U_{k′} is modified to

$${\tilde{U}}_{{k}^{′}} ( ϕ ) = {e}^{- \frac{i ϕ}{2}} [ cos ( \frac{ϕ}{2} ) {I}^{( N )} + i sin ( \frac{ϕ}{2} ) {U}_{{k}^{′}} ] .$$

This unitary maps a single photon incident at one input port to a superposition across the mode at the input and the output under the permutation Uₖ, with weighting controlled by the value of ϕ. Further modification of the phase settings may achieve mappings from one input to arbitrary pairs of output ports. As an example, suppose it is desired to map from input port p₁ to output ports q₁ and q₂ in the GMZI. This may be done so by first determining k₁, k₂ with U=WDₖ_{₁₍₂₎}W^{†}:p [symbol] q₁₍₂₎, and then choosing phase vector

$$\tilde{d} = {e}^{- \frac{i ϕ}{2}} [ cos ( \frac{ϕ}{2} ) {d}_{k} + i sin ( \frac{ϕ}{2} ) {d}_{{k}^{′}} ] .$$

The transfer matrix for this GMZI configuration is then

$$U ( ϕ ) = {e}^{- \frac{i ϕ}{2}} [ cos ( \frac{ϕ}{2} ) {U}_{k} + i sin ( \frac{ϕ}{2} ) {U}_{{k}^{′}} ] ,$$

where the individual phase settings are taken from the set {0, −ϕ, −1, −1−ϕ}. Note that a second input port p₂ is also mapped to the pair q₁ and q₂, where UₖU_{k′}:p₁→p₂. Here, a GMZI configured in this way (e.g., for Ũ(ϕ) equation above) may operate as a switchable pairwise coupler, which may be used in spatial and temporal multiplexing architecture.

In some embodiments, entangled states of multiple photonic qubits are created by coupling (spatial) modes of two (or more) qubits and performing measurements on other modes. By way of example, FIG. 16 shows a circuit diagram for a Bell state generator 1600 (BSG), e.g., that is used in some dual-rail-encoded photonic embodiments. For example, the Bell state generator 1600 is implemented as the first Bell state generator photonic circuit 1505 or the second Bell state generator photonic circuit 1510 in FIG. 15, discussed above. In the example of FIG. 16, waveguides (or modes) 1632-1 through 1632-4 are initially each occupied by a photon (indicated by a wavy line); waveguides (or modes) 1632-5 through 1632-8 are initially vacuum (unoccupied) modes. Those skilled in the art will appreciate that other combinations of occupied and unoccupied modes may be used.

A first-order mode coupling (e.g., implementing a transfer matrix T) is performed on pairs of occupied and unoccupied modes as shown by mode couplers 1631-1 through 1631-4, with each mode coupler 1631 having one input waveguide receiving a photon and one input waveguide receiving vacuum. Mode couplers 1631 may be, e.g., 50/50 beam splitters so that, for example, a photon entering on waveguide 1632-1 (or a photon entering on waveguide 1632-5) has a 50% probability of emerging on either output of mode coupler 1631-1. In the following description, mode couplers 1631 may also be referred to as “directional couplers.” Thereafter, a mode-information erasure coupling (e.g., implementing a four-mode mode spreading transform or a second-order Hadamard transfer matrix) is performed on one output mode of each directional coupler 1631 (in this example, output modes (e.g., waveguides) 1633-5 through 1633-8 provide inputs to the mode-information erasure coupling), as shown by mode coupler 16316. In the following description, mode coupler 16316 may also be referred to as a “mode coupler network” or “Hadamard network” (e.g., the passive compact Hadamard network architecture 1300 in FIG. 13A). Output modes (e.g., waveguides) 1633-5 through 1633-8 act as “heralding” modes that are measured and used to determine whether a Bell state was successfully generated on the four output modes (e.g., waveguides) 1633-1 through 1633-4. For example, detectors 1638-1 through 1638-4 can be coupled to the output modes (e.g., waveguides) 1633-5 through 1633-8 after second-order mode coupler 16316. Each detector 1638-1 through 1638-4 may output a classical data signal (e.g., a voltage level on a conductor) indicating whether it detected a photon (or the number of photons detected). These outputs may be coupled to classical decision logic circuit 1640, which determines whether a Bell state is present on the other four output modes (e.g., waveguides) 1633-1 through 1633-4. For example, the classical decision logic circuit 1640 is configured such that a Bell state is confirmed (also referred to as “success” of the Bell state generator) if and only if a single photon was detected by each of exactly two of detectors 1638-1 through 1638-4. In some embodiments, output modes (e.g., waveguides) 1633-1 through 1633-4 are mapped to the logical states of two qubits (Qubit 1 and Qubit 2), as indicated in FIG. 16. Specifically, in this example, the logical state of Qubit 1 is based on occupancy of output modes 1633-1 and 1633-2, and the logical state of Qubit 2 is based on occupancy of output modes 1633-3 and 1633-4. It should be noted that generation of a Bell state by the Bell state generator 1600 is a non-deterministic (or stochastic) process; that is, inputting four photons as shown does not guarantee that a Bell state will be created on output modes 1633-1 through 1633-4. In one implementation, the probability of success is 4/32; in another implementation, the success probability is 3/16. It should also be noted that there are six detection patterns with one photon in each of two of detectors 1638, and that the Bell state generator 1600 may be expected to produce a Bell state in all six possible arrangements of the four output modes. For a given choice of assignment of modes to dual-rail qubits (e.g., as shown in FIG. 16), the Bell state generator 1600 may produce any of the four two-qubit Bell states, as well as a “non-qubit” maximally entangled state. Different detection patterns at detectors 1638 may correspond to different types of Bell states being produced. In some embodiments, based on the particular detection pattern at detectors 1638, mode swaps are selectably applied to output modes 1633 in order to cast the Bell state into a particular type (e.g., a particular one of the four two-qubit Bell states defined above). In some embodiments, the mode swap is subsumed into subsequent operations without the need for active optical switches to implement selectable mode swapping at the output of the Bell state generator 1600.

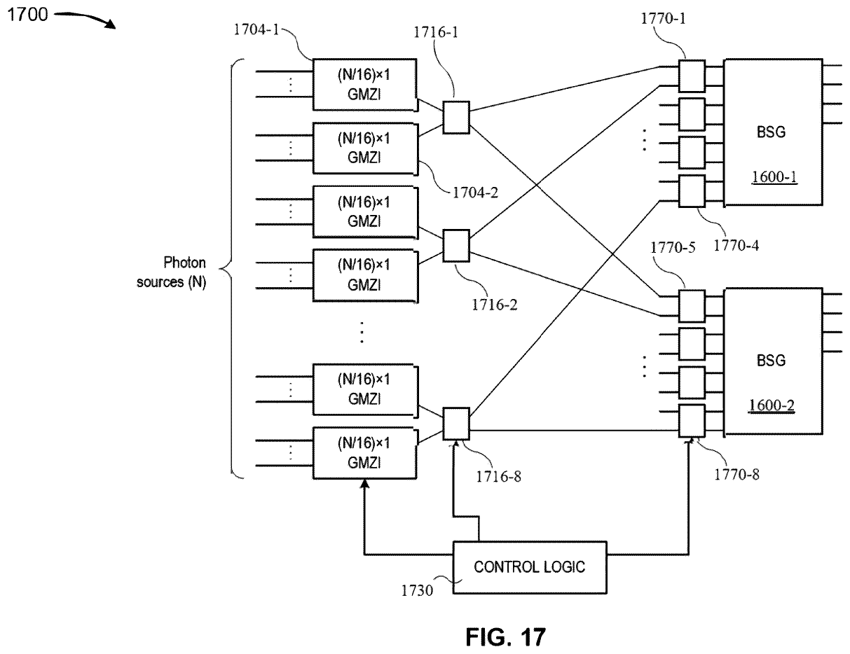

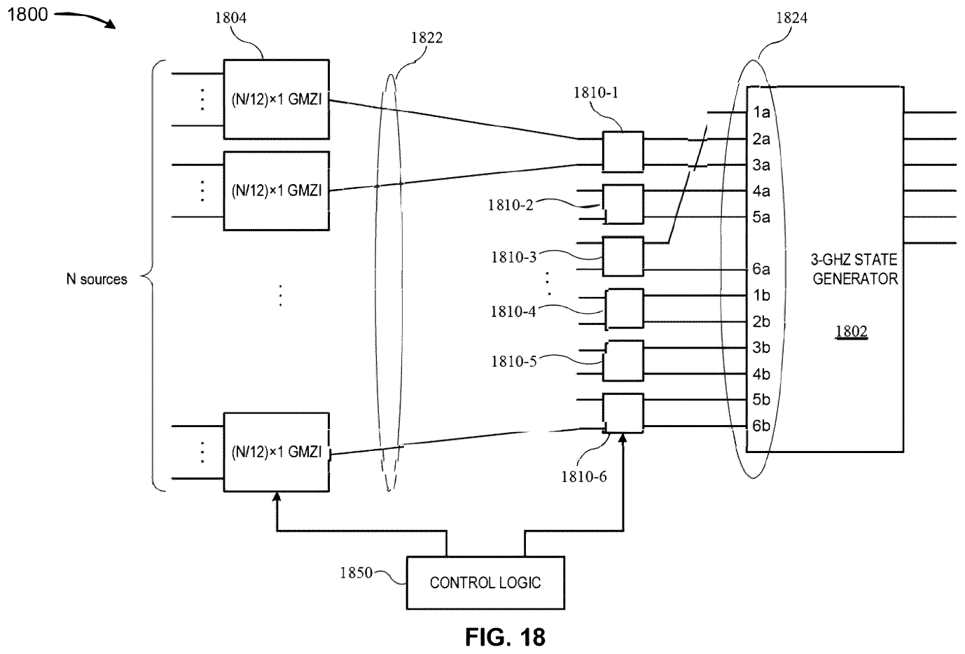

FIG. 17 and FIG. 18 describe examples of photonic devices in which one or more GMZIs are integrated in accordance with some embodiments. Such circuits and techniques may be applied in a wide variety of photonic systems and circuits, such as in the architectures of FIGS. 2A and 2B.

In some embodiments, the probability of generating a Bell state using the Bell state generator 1600 is further increased by providing additional selectability of inputs to muxes 1770 as well as additional Bell state generators (e.g., BSG 1600-2) that use extra photons that are generated. FIG. 17 shows a schematic diagram of a quantum photonics circuit 1700 according to some embodiments. The quantum photonics circuit 1700 includes a first Bell state generators 1600-1 and a second Bell state generator 1600-2, each of which may be implemented as described above. In some embodiments, the Bell state generator circuits in FIG. 17 operate concurrently on input photons generated by a set of N photon sources (not depicted in FIG. 17). Inputs of each Bell state generator 1600 may be coupled to a set of four 2×2 muxes as described above

In quantum photonics circuit 1700, the photon sources are coupled to the inputs of sixteen (N/16)×1 multiplexer circuits 1704, each of which may be implemented using a GMZI (e.g., the quantum GMZI switch architecture 800) coupled to a subset of N/16 of the photon sources. A set of eight 2×2 muxes 1716-1 through 1716-8 is disposed between the outputs of mux circuits 1704 and the inputs of 2×2 muxes 1770. The muxes 1716 may each be implemented, e.g., using a Mach-Zehnder interferometer (MZI), such as the quantum GMZI switch architecture 800. In some embodiments, each mux 1716 has inputs coupled to a different pair of mux circuits 1704, a first output coupled to one of muxes 1770-1 through 1770-4 for the first Bell state generator 1600-1, and a second output coupled to a corresponding one of muxes 1770-5 through 1770-8 for Bell state generator 1600-2. Thus, for example, switch 1716-1 has inputs coupled to multiplexer circuits 1704-1 and 1704-2, one output coupled to the mux 1770-1 (which couples to the first Bell state generator 1600-1) and one output coupled to the mux 1770-5 (which couples to the Bell state generator 1600-2). In this manner, each mux 1716-1 through 1716-8 may supply one photon to each of Bell state generators 1600-1 and 1600-2, and muxes 1770 for each Bell state generator 1600 may rearrange the photons into one of the 16 usable input states for the Bell state generator 1600.

Similar to other control logic circuits described herein, control logic 1730 (FIG. 17) and/or control logic 1850 (FIG. 18), may be implemented using a conventional electronic logic circuit (e.g., as described above with reference to the controllers 107A and 107B of FIG. 8), and may receive heralding signals from the N photon sources and may determine, based on the pattern of photon sources that generated photons. The mux circuits 1704 may provide a photon to each of muxes 1716. Each of muxes 1716 may receive 0, 1, or 2 photons, depending on the pattern of photon sources that generated photons. Based on the pattern of photons received at muxes 1716, control logic 1730 may determine switch settings for muxes 1716 such that photons are delivered to muxes 1770-1 through 1770-4 in a pattern that may be rearranged by muxes 1770-1 through 1770-4 into one of the 16 usable input states for the Bell state generator 1600-1 and/or such that photons are delivered to muxes 1770-5 through 1770-8 in a pattern that may be rearranged by muxes 1770-5 through 1770-8 into one of the 16 usable input states for Bell state generator 1600-2. Depending on the number of photons generated for a given time bin, four photons may be provided to zero, one, or both of the Bell state generators 1600-1 and 1600-2. Control logic 1730 may also control muxes 1770 to perform the appropriate rearrangement, as described above. Via an appropriate combination of switch settings for muxes 1716 and 1770, any distribution of four or more photons across the outputs of mux circuits 1704 may be rearranged into a usable input state for at least one of the Bell state generators 1600. Depending on which photon sources generate photons (and on the non-deterministic production of Bell states by the Bell state generators 1600-1 and 1600-2), quantum photonics circuit 1700 may produce 0, 1 or 2 Bell states for each time bin.

While the previous examples illustrate the use of 2×2 muxes to increase the probability of providing a usable input state for a Bell state generator circuit, other embodiments may apply a similar principle to other circuits that operate on groups of photons. For example, FIG. 18 shows a simplified circuit schematic of an optical circuit 1800 according to some embodiments. An optical circuit 1800 includes a 3-GHZ state generator circuit 1802 that may generate a 3-GHZ state (e.g., cluster state, multi-partite entangled state of photons) of dual-rail encoded qubits from a group of six input photons. For purposes of understanding the present disclosure, it suffices to understand that 3-GHZ state generator circuit 1802 includes twelve input waveguides 1824, individually labeled for convenience as 1a-6a and 1b-6b. Similarly, to Bell state generator circuits described above, the input waveguides may be considered as paired (waveguide 1a is paired with waveguide 1b, waveguide 2a with waveguide 2b, etc.), and a usable input state for 3-GHZ state generator circuit 1802 (i.e., an input state that allows 3-GHZ state generator circuit 1802 to generate a 3-GHZ state) has exactly one photon in each pair of input waveguides. Since the choice of which input waveguide in a pair is occupied may be made independently for each pair of waveguides, 3-GHZ circuit has 26=64 usable input states. There are 924 distinct ways to distribute six photons across 12 waveguides. The optical circuit 1800 may be designed to support rearrangement of six photons at outputs 1822 of mux circuits 1804 into one of the 64 usable input states.

To provide photons to 3-GHZ state generator circuit 1802, a number N of photon sources (e.g., heralded single-photon generators as described above) may be provided to a set of twelve mux circuits 1804. Each mux circuit 1804 can be a (N/12)×1 multiplexer circuit and may be implemented using a GMZI. A set of six 2×2 muxes 1810 is disposed between the outputs 1822 of mux circuits 1804 and the input waveguides 1824 of 3-GHZ state generator circuit 1802. Each 2×2 mux 1810 may be implemented, e.g., using a Mach-Zehnder interferometer (MZI). Each mux 1810 has two inputs coupled to a different pair of mux circuits 1804 and two outputs coupled to two different input waveguides 1824 of GHZ state generator circuit 1802 that belong to different pairs. In the example shown, mux 1810-1 has output modes coupled to input waveguides 2a and 3a of 3-GHZ state generator circuit 1802. Mux 1810-2 has output modes couples to input waveguides 4a and 5a. Mux 1810-3 has output modes coupled to input waveguides 6a and 1a. Mux 1810-4 has output modes coupled to input waveguides 1b and 2b. Mux 1810-5 has output modes coupled to input waveguides 3b and 4b. Mux 1810-6 has output modes coupled to input waveguides 5b and 6b.

Like the 2×2 muxes 1716 for Bell state generator circuits described above, the 2×2 muxes 1810 may be used to rearrange photons from the mux circuits 1804, increasing the number of distributions of photons that may result in a usable input state for the 3-GHZ state generator circuit 1802. Each mux 1810 may direct a photon to either of two inputs to the 3-GHZ state generator circuit 1802, thereby enabling more of the 924 possible distributions of four photons across 12 waveguides to be used. For the arrangement of the muxes 1810 shown in FIG. 18, it may be shown that 666 of the 924 possible distributions (or patterns) of six photons at the outputs 1822 of mux circuits 1804 may be rearranged by operation of the muxes 1810 into one or another of the 64 usable input states at the 3-GHZ circuit input waveguides 1824. Further, if blocking switches are used to prevent photons from entering more than six of the 3-GHZ circuit input waveguides 1824, distributions with more than six photons at the outputs 1822 of mux circuits 1804 may also be used to provide usable input states.

As with crossing networks, in optical circuit 1700, the particular pattern of connections between the muxes 1810 and input waveguides 1824 of the 3-GHZ state generator circuit 1802 determines how many of the possible distributions of six photons at the outputs 1822 of mux circuits 1804 may yield usable input states at the 3-GHZ circuit input waveguides 1824. As described above the 3-GHZ state generator circuit 1802 has six pairs of inputs, where “pair 1” includes waveguides 1a and 1b, “pair 2” includes waveguides 2a and 2b, etc.). With the connections shown in FIG. 18, the mux 1810-1 may deliver photons to the input waveguide 2a of pair 2 and to the input waveguide 3a of pair 3; the mux 1810-2 may deliver photons to the input waveguide 4a of pair 4 and to the input waveguide 5a of pair 5; the mux 1810-3 may deliver photons to the input waveguide 1a of pair 1 and to the input waveguide 6a of pair 6; the mux 1810-4 may deliver photons to the input waveguide 1b of pair 1 and to the input waveguide 2b of pair 2; the mux 1810-5 may deliver photons to the input waveguide 3b of pair 3 and to the input waveguide 4b of pair 4; and the mux 1810-6 may deliver photons to the input waveguide 5b of pair 5 and to the input waveguide 6b of pair 6. In this manner, each pair of inputs of the 3-GHZ state generator circuit 1802 is coupled to two different muxes 1810, and each mux 1810 is coupled to two different upstream circuits (in this case, two different (N/12)×1 multiplexer circuits 1804. This configuration allows a given pair of input waveguides 1824 of the 3-GHZ state generator circuit 1802 to receive a photon from any one of four different upstream circuits and allows a photon from a given upstream circuit to be delivered to any one of two pairs of the input waveguides 1824 of the 3-GHZ state generator circuit 1802. Thus, in a case where one pair of the input waveguides 1824 would (in the absence of the muxes 1810) receive two photons, one of the two photons may be rerouted to either of two other pairs of input waveguides. For example, if the pattern of photons at the outputs 1822 of mux circuits 1804 is such that inputs 1a and 1b would both receive photons in the absence of muxes 1810 (e.g., switches), the presence of muxes 1810 can be used to reroute one of those photons either to input 6a (using switch 1810-3) or to input 2b (using switch 1810-4), depending on which of input pairs 6 or 2 would not otherwise receive any photon. In this manner, 666 of the 924 possible distributions of six photons at the outputs 1822 of mux circuits 1804 can be rearranged by the muxes 1810 to provide usable input states at the 3-GHZ circuit input waveguides 1824. It is noted that other arrangements of the muxes 1810 may also allow an “extra” photon associated with one pair of input waveguides 1824 to be rerouted to either of two other pairs, and any such arrangement may be used. In some embodiments, additional 2×2 muxes or switches may be added to allow some or all of the remaining 258 possible distributions of six photons at the outputs 1822 of mux circuits 1804 to be rearranged into a usable input state at the 3-GHZ circuit input waveguides 1824. For example, an additional set of 2×2 muxes can be provided upstream of the muxes 1810 to further increase the probability of providing a usable input state to the 3-GHZ state generator circuit 1802.

The Bell state generator 1600 and the 3-GHZ state generator circuit 1802 are examples of “entanglement circuits” that may generate entangled quantum states from a set of single-photon inputs. Entanglement circuits such as these examples may be understood as operating on qubits represented using a dual-rail encoding, with each qubit encoded on a pair of waveguides as described above. For some types of entanglement circuits, a usable input state may be an input state that corresponds to a set of qubits entering the entanglement circuit in a known logical state (which, for each qubit, may be either logical 0 or logical 1). For a dual-rail encoding, inputting a qubit in a known logical state corresponds to inputting a photon in one or the other (but not both) of a pair of input waveguides, and a usable input state may be an arrangement of photons such that exactly one of the pair of waveguides encoding each qubit is occupied by a photon, as in the Bell state generator and the 3-GHZ circuits used in examples above. If photons from a set of non-deterministic photon sources that operate independently of each other are input to the input waveguides, some patterns of photons will correspond to a usable input state and others will not. Providing 2×2 muxes between pairs of the photon sources and the input waveguides of the entanglement circuits may generate patterns of photons (e.g., photons at the outputs of a set of N×1 multiplexer circuits) that do not correspond to a usable input state to be rearranged into a different pattern of photons that does correspond to a usable input state. In some embodiments, to optimize the number of patterns of photons that are rearranged into usable input states, the 2×2 muxes are coupled to the inputs such that an “extra” photon in the original pattern (e.g., a photon that would result in photons entering both input waveguides of the same pair of input waveguides) is rerouted to either of two other pairs of input waveguides. By increasing the number of patterns of generated photons that result in usable input states, this optical switching devices may increase the probability that the entanglement circuit generates the desired entangled state. It should be understood that operation of an entanglement circuit such as a Bell state generator or a 3-GHZ circuit may be non-deterministic and that providing a usable input state does not guarantee that the desired entangled state will be produced. In some embodiments, additional layers of 2×2 muxes are included to further increase the probability of providing a usable input state to the entanglement circuit.

FIG. 19 shows an example of a multi-device architecture 1900 for implementing classical and quantum light processing circuitry in accordance with some embodiments. The example illustrated in FIG. 19, the first quantum logic device 1905 is interconnected using a plurality of optical connections 1907 to a second quantum logic device 1950. For example, each quantum logical device comprises an instance of the photonic processing architecture 200 shown in FIG. 2A or a single photon source on a chip (e.g., PIC 290), as discussed with reference to FIG. 2C above.

In accordance with some embodiments, each quantum logic device 1905 comprises a GMZI comprising a plurality of phase shifters, including a set of fast phase shifters 1910 and a set of the slow phase shifters 1915. In some embodiments, the second quantum logic device 1950 also includes a set of fast phase shifters 1955 and a set of slow phase shifters 1960. In some embodiments, the slow phase shifters are first calibrated (e.g., using bright light) to zero out the phase arms in each device (e.g., according to various fabrication material and temperature differences) and further calibrate the GMZI switches to function as one or more submodules (e.g., the quantum GMZI submodules 1525, 1530, 1535 in FIG. 15). Further, and in accordance with some embodiments, the slow phase shifters 1915 and 1960 are used to zero out and calibrate the phase to minimize the phases between the first quantum logic device 1905 and the second quantum logic device 1950 via the plurality of optical connections 1907. Once the slow phase shifters 1915 and 1960 (and additional phase shifters in additional quantum devices) are calibrated, the fast phase shifters 1910 and 1955 may rapidly perform phase shifting to implement quantum light processing. For example, fast phase shifters 1910 and 1955 may perform application specific processing using one or more submodules and dynamically reconfigure to perform error corrections or further adjustments during processing (e.g., adjustments to counter temperature changes of the multi-device architecture 1900).

As an additional example, the first quantum logic device 1905 and the second quantum logic device 1950 are non-deterministic photon sources and the fast phase shifters are configured on the fly when a herald photon is directed to ensure the GMZI is in a proper N-to-1 configuration to direct the corresponding single photon to a single output port of the GMZI.

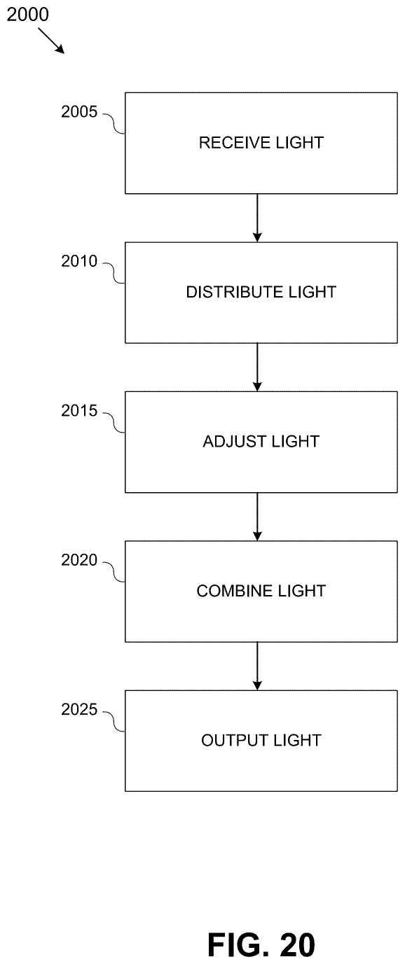

FIG. 20 shows a flow diagram 2000 of a method for multiplexing light in an optical device comprising one or more GMZIs in accordance with some embodiments. At operation 2005, an optical device receives light. For example, at operation 2005, quantum light (e.g., single photons or pairs of entangled photons) is received on a plurality of input ports of a switch implementing quantum GMZI switch architecture 800 in FIG. 8.

At operation 2010, the optical device distributes the light. For example, at operation 2010, the first Hadamard network 805 distributes the quantum light. As an example, if a single photon is received by the first Hadamard network 805 the mode (e.g., probability density) of the photon may be distributed across all output ports of the Hadamard network. As an additional example, if photons are received at two or more different ports of the first Hadamard network 805, then the two photons interfere in the paths of the Hadamard network and a permutation of the two or more different photons is outputted and distributed from the output ports of the Hadamard network.

At operation 2015, the optical device adjusts the light. For example, at operation 2015, a plurality of the waveguide arm phase shifters 810 are used to adjust one or more phases of quantum light on the different waveguide arms of the GMZI. In some embodiments, the phase settings of the waveguide arm phase shifters 810 are set using a transfer matrix discussed above (e.g., to mux all inputs into a single output as in a N-to-1 configuration, or to create muxed permutations of outputs in a N-to-M configuration). At operation 2020, the optical device combines the light. For example, at operation 2020, the second Hadamard network 825 combines the phase shifted quantum light to one or more output ports.

At operation 2025, the optical device outputs the light. For example, at operation 2025, the second Hadamard network 825 outputs the light from the output ports or waveguides, in accordance with some embodiments.

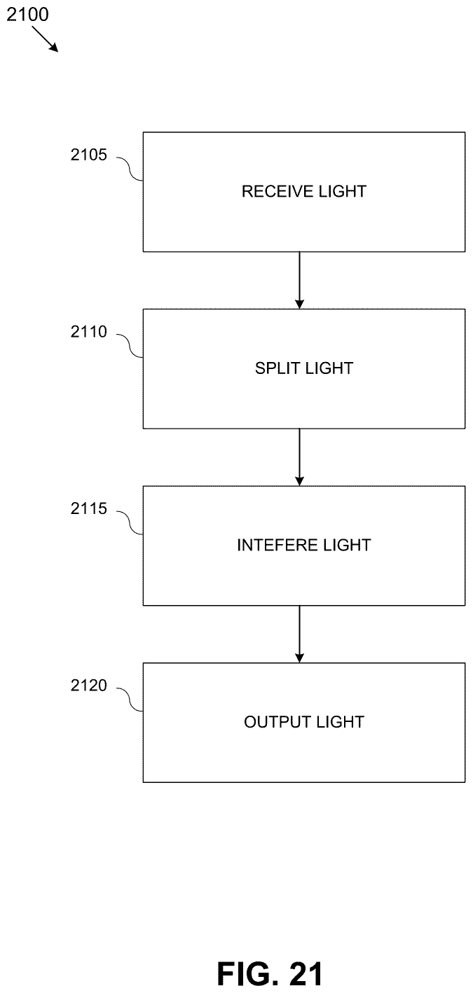

FIG. 21 shows a flow diagram 2100 of a method for splitting light in a coupler network (e.g., Hadamard network) in accordance with some embodiments. At operation 2105, an optical device receives light. For example, at operation 2105, quantum light is received on a plurality of input ports 1114 of a quantum optical coupler scalable network (e.g., the scalable sub-network unit 1150 in FIG. 11B). At operation 2110, the optical device distributes the light. For example, at operation 2010, the quantum light is distributed using the array of splitters 1115 (e.g., directional couplers), the Euler bends 1117, and the crossing network 1120.

At operation 2115, the optical device interferes or combines the light. For example, the quantum light (e.g., single photon, or photon pairs input on different input ports) interfere via the different couplers of operation 2010. At operation 2120, the optical device outputs the light. For example, the quantum light is output from one or more of the output ports 1123.

FIGS. 22A-22E show scaling of the quantum light network (e.g., the scalable sub-network unit 1150 in FIG. 11B) in accordance with some embodiments. In FIG. 22A, a coupler network array 2200 comprises an array of directional couplers 2205 that connect to coupler network array (e.g., crossing couplers) 2210 (e.g., using s-bends, Euler bends), which output to another array of directional couplers 2215.

FIG. 22B shows the coupler network array 2200 integrated into a larger coupler network array 2210 (e.g., crossing couplers) that include an array 2212 and an array 2214 that are composed of arrays of directional couplers, Euler bends, and crossing networks, as discussed above.

FIG. 22C shows the coupler network array 2220 integrated into a larger coupler network array 2230 that include a coupler network array 2232 and a coupler network array 2234 that are composed of arrays of directional couplers, Euler bends, and crossing networks, as discussed above. For example, integrating the coupler network array 2220 with network 2231 forms coupler network array 2232.

FIG. 22D shows the larger coupler network array 2230 integrated into a larger coupler network array 2240 that include a coupler network array 2242 and a coupler network array 2244 that are composed of arrays of directional couplers, Euler bends, and crossing networks, as discussed above.

FIG. 22E shows an example coupler network 2250 that is created by adding an additional network coupler level to the coupler network array 2242 and coupler network array 2244. The coupler network 2250 is an example of a first Hadamard network 805, which may be integrated on a single PIC chip (e.g., the PIC 290 in FIG. 2C).

FIG. 23 shows an example coupler network 2300 (e.g., the first Hadamard network 805) with a self-similar structure that enables the scaling of the coupling network in a way that maintains the phase and remains low loss as additional levels of the network are added. As illustrated in FIG. 23, the empty shape area SI is similar to empty shape area S2A and S2B, which are similar to empty shape areas S3A-S3D, which form a self-similar fractal shape that may scale to create large quantum light splitter networks.

The following are example embodiments:

Example 1: A method for processing light in an integrated generalized Mach-Zehnder Interferometer (GMZI), the method comprising: receiving, by a first coupler network in the GMZI, a quantum state of light comprising one or more photons; distributing, using the first coupler network, the quantum state of light to one or more of a plurality of waveguide arms in the GMZI; adjusting, using a plurality of phase shifters in the GMZI, one or more phases of the quantum state of light distributed by the first coupler network, a phase shifter of the plurality of phase shifters adjusting a phase portion of the quantum state of light in one of the plurality of waveguide arms, each waveguide arm of the waveguide arms comprising a first phase shifter and a second phase shifter; receiving, by a second coupler network in the GMZI, the quantum state of light having phases adjusted by the plurality of phase shifters; combining, using the second coupler network, the quantum state of light to form combined quantum state of light onto one or more outputs of the waveguide arms; and outputting the combined quantum state of light from the one or more outputs of the waveguide arms.

Example 2: The method of Example 1, wherein the first phase shifter is a switching phase shifter and the second phase shifter is a trim phase shifter.

Example 3: The method of Example 1 or Example 2, wherein the first phase shifter is an electro-optic phase shifter and the second phase shifter is a heat-based phase shifter.

Example 4: The method of any one of Examples 1-3, wherein the first phase shifter is configured to complete phase shifts faster than the second phase shifter.

Example 5: The method of any one of Examples 1-4, wherein the first phase shifter is a BTO based phase shifter and the second phase shifter is a heater.

Example 6: The method of any one of Examples 1-5, wherein first phase shifter is configured to apply a phase shift in a range between a range of zero to, and wherein the second phase shifter is configured to apply a phase shift in a range between zero to 2×.

Example 7: The method of any one of Examples 1-6, wherein the first phase shifter and the second phase shifter are electro-optic phase shifters that switch approximately at a similar speed, and wherein the second phase shifter is implemented for equalization phase setting to calibrate the GMZI and wherein the first phase shifter is implemented at runtime to switch light that is input into the GMZI.

Example 8: The method of any one of Examples 1-7, wherein the method further comprises: detecting light output by the GMZI using one or more photodetectors; and adjusting a plurality of second phase shifters on the waveguide arms to reduce a difference in phases between the plurality of waveguide arms based on the light detected by the one or more photodetectors.

Example 9: The method of any one of Examples 1-8, wherein temperature variations and optical loss in the GMZI cause differences in phases that are reduced by adjusting a plurality of second phase shifters on the waveguide arms of the GMZI.

Example 10: The method of any one of Examples 1-9, wherein each second phase shifter is used to set an equalization phase setting in the GMZI to process the quantum state of light.

Example 11: The method of any one of Examples 1-10, wherein the equalization phase setting is set based on optical couplings between a first GMZI and a second GMZI.

Example 12: The method of any one of Examples 1-11, further comprising: identifying updated first phase shifter setting data, the updated first phase shifter setting data comprising adjustments to first phase shifters in the GMZI; and adjusting a plurality of first phase shifters on the waveguide arms using the updated first phase shifter setting data.

Example 13: The method of any one of Examples 1-12, further comprising: generating updated first phase shifter setting data based on detection of single photons using one or more single photon detectors.

Example 14: The method of any one of Examples 1-13, wherein the single photons are heralding photons and the quantum state of light comprises corresponding signal photons.

Example 15: A photonic integrated circuit comprising a quantum light switch, the quantum light switch comprising: a first coupler network to receive a quantum state of light comprising one or more photons, the first couple network configured to distribute the quantum state of light to one or more of a plurality of arms of the quantum light switch; a plurality of phase shifters on the plurality of arms of the quantum light switch, the plurality of phase shifters configured to couple the quantum state of light from the first coupler network, a phase shifter of the plurality of phase shifters to adjust a phase of the quantum state of light on one of the plurality of arms, each arm of the plurality of arms comprising a first phase shifter and a second phase shifter; and a second coupler network to couple phase adjusted quantum state of light from the plurality of phase shifters and to combine the phase adjusted quantum state of light in the second coupler network to form combined quantum state of light.

Example 16: The photonic integrated circuit of Example 15, wherein the first coupler network comprises a first plurality of optical couplers to distribute the quantum state of light, and wherein the second coupler network comprises a second plurality of optical couplers to combine the phase adjusted quantum state of light.

Example 17: The photonic integrated circuit of Example 15 or Example 16, wherein the quantum light switch comprises a generalized Mach-Zehnder Interferometer (GMZI) to switch quantum light, wherein the quantum state of light comprises the one or more photons encoded as dual-rail qubits on a pair of waveguides, wherein a pair of the plurality of arms of the quantum light switch comprise the pair of waveguides that propagate the dual-rail qubits.

Example 18: The photonic integrated circuit of any one of Examples 15-17, wherein the first phase shifter and the second phase shifter are electro-optic phase shifters that switch approximately at a similar speed, and wherein the second phase shifter is implemented for equalization phase setting to calibrate the GMZI and wherein the first phase shifter is implemented at runtime to switch light that is input into the GMZI.

Example 19: The photonic integrated circuit of any one of Examples 15-18, wherein the first phase shifter is a switching phase shifter and the second phase shifter is a trim phase shifter.

Example 20: The photonic integrated circuit of any one of Examples 15-19, wherein the first phase shifter is an electro-optic phase shifter and the second phase shifter is a heat-based phase shifter.

Example 21: The photonic integrated circuit of any one of Examples 15-20, wherein one or more photodetectors detect light output from the quantum light switch using one or more photodetectors, and wherein the light detected by the one or more photodetectors is used to adjust a plurality of second phase shifters on the plurality of arms to reduce a difference in phases between the plurality of arms based on the light detected by the one or more photodetectors.

Example 22: The photonic integrated circuit of any one of Examples 15-21, wherein temperature variations and optical loss in the quantum light switch cause differences in phases that are reduced by adjusting the plurality of second phase shifters.

Example 23: The photonic integrated circuit of any one of Examples 15-22, wherein the second phase shifters are used to set an equalization phase setting in the quantum light switch to process the quantum state of light.

Example 24: The photonic integrated circuit of any one of Examples 15-23, wherein the equalization phase setting is set based on optical couplings between a first GMZI and a second GMZI.

Example 25: The photonic integrated circuit of any one of Examples 15-24, further comprising: control circuitry that stores first phase shifter settings data for settings to apply to first phase shifters in response to detecting single photons being input into the quantum light switch.

Example 26: The photonic integrated circuit of any one of Examples 15-25, wherein the control circuitry comprises a look-up table storing the first phase shifter settings, the look-up table storing updated first phase shifter setting data to apply to the first phase shifters based on single photons being input onto one or more arms of the quantum light switch.

Example 27: The photonic integrated circuit of any one of Examples 15-26, wherein the quantum state of light is generated from a photonic integrated single photon source that generates photon pairs, wherein the photon pairs comprise a signal photon and an idler photon, wherein the signal photon is detected and the control circuitry receives electrical signaling to indicate which input of the quantum light switch the corresponding signal photon is being input.

Example 28: The photonic integrated circuit of any one of Examples 15-27, wherein the first phase shifter is configured to complete phase shifts faster than the second phase shifter.

Example 29: The photonic integrated circuit of any one of Examples 15-28, wherein the first phase shifter is a BTO based phase shifter and the second phase shifter is a heater.

Example 30: The photonic integrated circuit of any one of Examples 15-29, wherein first phase shifter is configured to apply a phase shift in a range between a range of zero to x, and wherein the second phase shifter is configured to apply a phase shift in a range between zero to 2×.

Example 31: A photonic integrated circuit (PIC) comprising: a plurality of input ports to input a quantum state of light into the PIC; a waveguide network comprising: a fan-in crossing network to combine the quantum state of light; a set of power splitters that are coupled to the fan-in crossing network; and a plurality of output ports to output the quantum state of light.

Example 32: The PIC of Example 31, wherein the waveguide network is a first waveguide network and wherein the PIC further comprises a second waveguide network, the second waveguide network comprising an additional fan-in crossing network that is coupled to an additional set of power splitters.

Example 33: The PIC of Example 31 or Example 32, further comprising: a third waveguide network that comprises a further fan-in crossing network and a further set of power splitters.

Example 34: The PIC of any one of Examples 31-33, wherein outputs of the first waveguide network and the second waveguide network are coupled to inputs of the third waveguide network.

Example 35: The PIC of any one of Examples 31-34, further comprising a plurality of waveguide bends to couple light from the first waveguide network and the second waveguide network to the third waveguide network.

Example 36: The PIC of any one of Examples 31-35, wherein the quantum state of light comprises one or more single photons, and wherein the one or more single photons are in superposition across the output ports.

Example 37: The PIC of any one of Examples 31-36, wherein the set of power splitters comprise 50/50 optical power splitters.

Example 38: The PIC of any one of Examples 31-37, wherein the set of power splitters comprise directional couplers.

Example 39: The PIC of any one of Examples 31-38, wherein the comprise multimode interference couplers.

Example 40: The PIC of any one of Examples 31-39, wherein the quantum state of light propagates along a propagation direction in the PIC, and wherein the fan-in crossing network comprises a plurality of crossing coupler layers having layer sizes arranged in a decreasing order that decreases along the propagation direction.

Example 41: The PIC of any one of Examples 31-40, wherein each crossing coupler layer comprises a plurality of crossing couplers, wherein a portion of the plurality of crossing couplers have unterminated output ports.

Example 42: The PIC of any one of Examples 31-41, wherein the plurality of crossing couplers comprise multi-mode interference (MMI) couplers.

Example 43: The PIC of any one of Examples 31-42, wherein the MMI couplers are star couplers.

Example 44: The PIC of any one of Examples 31-43, further comprising: a fourth waveguide network that comprises a fan-out crossing network and supplementary set of power splitters that are coupled to the fan-out crossing network.

Example 45: The PIC of any one of Examples 31-44, wherein the quantum state of light propagates along a propagation direction in the PIC, and wherein the fan-out crossing network comprises a plurality of crossing coupler layers having layer sizes arranged in an increasing order that increases along the propagation direction.

Example 46: A method comprising: inputting quantum light into an input interface of a photonic integrated circuit, the input interface comprising a plurality of input ports that input into a waveguide network, the waveguide network comprising a layer of directional couplers, a fan-in crossing coupler network, and a plurality of output ports of an output interface, the layer of directional couplers being coupled to the fan-in crossing coupler network and the fan-in crossing coupler network being coupled to the plurality of output ports; splitting the quantum light using the layer of directional couplers; interfering the quantum light in the fan-in crossing coupler network, the fan-in crossing coupler network comprising a set crossing coupler layers having layer sizes arranged in a decreasing order; and outputting the quantum light at the output interface of the waveguide network, the quantum light being output from one or more of the plurality of output ports based on interference in the fan-in crossing network and which input ports of the plurality of input ports receive the quantum light.

Example 47: The method of Example 46, wherein a first waveguide network comprises the waveguide network, and wherein a second waveguide network is adjacent to the first waveguide network, wherein the second waveguide network comprises an additional layer of directional couplers that are coupled to an additional crossing network to split, interfere, and output additional quantum light to additional output ports of the second waveguide network.

Example 48: The method of Example 46 or Example 47, wherein a third waveguide network is coupled to the first waveguide network and the second waveguide network, the third waveguide network comprising a further layer of directional couplers that are coupled to a further crossing coupler network to form additional quantum light from the quantum light from the first waveguide network and additional quantum light from the second waveguide network.

Example 49: The method of any one of Examples 46-48, wherein the directional couplers and the crossing coupler forms an empty shape, and wherein the second waveguide network and the third waveguide network form a self-similar empty shape that is similar to the empty shape formed by the crossing coupler layers and the directional couplers, and wherein additional scaled up fan-in networks create the self-similar empty shape such that light remains in phase as it is split and propagates across different portions of the first, second or third waveguide networks.

Example 50: An optical phase shifter, comprising: a first electrode having a distributed shape; a second electrode; an optical waveguide arranged between the first electrode and the second electrode; and an electro-optical material arranged between the optical waveguide and the first electrode and between the optical waveguide and the second electrode.

Example 51: The optical phase shifter of Example 50, wherein the electro-optical material is in an active layer, and wherein the optical waveguide is in a waveguide layer that is disposed on the active layer, wherein the first electrode and the second electrode are electrically connected to portions of the active layer.

Example 52: The phase shifter of Example 50 or Example 51, wherein the phase shifter is a traveling wave electrode, and wherein the first and second electrodes are operable to receive radio frequency electrical signaling to implement traveling wave phase shifting to light in the optical phase shifter.

Example 53: The phase shifter of any one of Examples 50-52, wherein the first and second electrodes are configured to have an electrical velocity that matches an optical velocity of the optical waveguide.

Example 54: The phase shifter of any one of Examples 50-53, wherein the second electrode has a distributed shape.

Example 55: The phase shifter of any one of Examples 50-54, wherein the distributed shape of the first electrode comprises an array of elements protruding toward the optical waveguide.

Example 56: The phase shifter of any one of Examples 50-55, wherein the first and second electrodes are configured to apply an electrical field to the electro-optical material such that the electro-optical material causes a phase shift in light propagating in the electro-optical material.

Example 57: The phase shifter of any one of Examples 50-56, wherein the first and second electrodes are configured to apply heat to the optical waveguide to change an index of refraction of the optical waveguide.

Example 58: The phase shifter of any one of Examples 50-57, wherein the first electrode comprises a plurality of electrode segments that are separated by gaps.

Example 59: The phase shifter of any one of Examples 50-58, wherein at least one of the first and second electrodes comprise metal electrodes.

Example 60: The phase shifter of any one of Examples 50-59, wherein the optical waveguide has a non-linear shape between the first and second electrodes.

Example 61: The phase shifter of any one of Examples 50-60, wherein the optical waveguide is a photonic crystal waveguide.

Example 62: The phase shifter of any one of Examples 50-61, further comprising: an electrical source coupled to a first end of the first electrode; and a termination resistor coupled to a second end of the first electrode, the second end being opposite of the first end.

Example 63: The phase shifter of any one of Examples 50-62, wherein the electrical source is further coupled to the second electrode.

Example 64: The phase shifter of any one of Examples 50-63, wherein the optical waveguide comprises a waveguide resonator that is optically coupled to a second waveguide.

Example 65: The phase shifter of any one of Examples 50-64, wherein: the optical waveguide resonator has an elliptical shape; second electrode is arranged inside of the elliptical shape; and the first electrode is arranged outside of the elliptical shape.

Example 66: An electro-optical circuit, comprising: the phase shifter of any one of Examples 50-65; a first waveguide network that is coupled to an input of the optical waveguide; a second waveguide network that is coupled to an output of the phase shifter.

Example 67: The electro-optical circuit of any one of Examples 50-66, wherein the first waveguide network and the second waveguide network are Hadamard waveguide networks.

Example 68: The electro-optical circuit of any one of Examples 50-67, wherein the first coupling component is a 2×2 coupler.

It will also be understood that, although the terms first, second, etc. are, in some instances, used herein to describe various elements, these elements should not be limited by these terms. These terms are used only to distinguish one element from another. For example, a first tuner could be termed a second tuner, and, similarly, a second tuner could be termed a first tuner, without departing from the scope of the various described embodiments. The first tuner and the second tuner are both tuners, but they are not the same tuner.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A photonic integrated circuit (PIC) comprising:
a plurality of input ports to input a quantum state of light into the PIC;
a waveguide network comprising:
a fan-in crossing network to combine the quantum state of light; and
a set of power splitters that are coupled to the fan-in crossing network; and
a plurality of output ports to output the quantum state of light.

2. The PIC of claim 1, wherein the waveguide network is a first waveguide network and wherein the PIC further comprises a second waveguide network, the second waveguide network comprising an additional fan-in crossing network that is coupled to an additional set of power splitters.

3. The PIC of claim 2, further comprising: a third waveguide network that comprises a further fan-in crossing network and a further set of power splitters.

4. The PIC of claim 3, wherein outputs of the first waveguide network and the second waveguide network are coupled to inputs of the third waveguide network.

5. The PIC of claim 4, further comprising a plurality of waveguide bends to couple light from the first waveguide network and the second waveguide network to the third waveguide network.

6. The PIC of claim 1, wherein the quantum state of light comprises one or more single photons, and wherein the one or more single photons are in superposition across the output ports of the PIC.

7. The PIC of claim 1, wherein the set of power splitters comprise 50/50 optical power splitters.

8. The PIC of claim 1, wherein the set of power splitters comprise directional couplers.

9. The PIC of claim 1, wherein the comprise multimode interference couplers.

10. The PIC of claim 1, wherein the quantum state of light propagates along a propagation direction in the PIC, and wherein the fan-in crossing network comprises a plurality of crossing coupler layers having layer sizes arranged in a decreasing order that decreases along the propagation direction.

11. The PIC of claim 10, wherein each crossing coupler layer comprises a plurality of crossing couplers, wherein a portion of the plurality of crossing couplers have unterminated output ports.

12. The PIC of claim 11, wherein the plurality of crossing couplers comprise multi-mode interference (MMI) couplers.

13. The PIC of claim 12, wherein the MMI couplers are star couplers.

14. The PIC of claim 1, further comprising:
a fourth waveguide network that comprises a fan-out crossing network and supplementary set of power splitters that are coupled to the fan-out crossing network.

15. The PIC of claim 14, wherein the quantum state of light propagates along a propagation direction in the PIC, and wherein the fan-out crossing network comprises a plurality of crossing coupler layers having layer sizes arranged in an increasing order that increases along the propagation direction.

16. A method comprising:
inputting quantum light into an input interface of a photonic integrated circuit, the input interface comprising a plurality of input ports that input into a waveguide network, the waveguide network comprising a layer of directional couplers, a fan-in crossing coupler network, and a plurality of output ports of an output interface, the layer of directional couplers being coupled to the fan-in crossing coupler network and the fan-in crossing coupler network being coupled to the plurality of output ports;
splitting the quantum light using the layer of directional couplers;
interfering the quantum light in the fan-in crossing coupler network, the fan-in crossing coupler network comprising a set crossing coupler layers having layer sizes arranged in a decreasing order; and
outputting the quantum light at the output interface of the waveguide network, the quantum light being output from one or more of the plurality of output ports based on interference in the fan-in crossing network and which input ports of the plurality of input ports receive the quantum light.

17. The method of claim 16, wherein a first waveguide network comprises the waveguide network, and wherein a second waveguide network is adjacent to the first waveguide network, wherein the second waveguide network comprises an additional layer of directional couplers that are coupled to an additional crossing network to split, interfere, and output additional quantum light to additional output ports of the second waveguide network.

18. The method of claim 17, wherein a third waveguide network is coupled to the first waveguide network and the second waveguide network, the third waveguide network comprising a further layer of directional couplers that are coupled to a further crossing coupler network to form additional quantum light from the quantum light from the first waveguide network and additional quantum light from the second waveguide network.

19. The method of claim 18, wherein:
the directional couplers and the fan-in crossing coupler network form an empty shape;
the second waveguide network and the third waveguide network form a self-similar empty shape that is similar to the empty shape; and
additional scaled up fan-in networks create the self-similar empty shape such that light remains in phase as it is split and propagates across different portions of the first, second or third waveguide networks.
